(19) United States
(12) Patent Application Publication
(10) Pub. No.: US 2016/0171179 A1
(43) Pub. Date: Jun. 16, 2016

(54) SYSTEM AND METHOD FOR INVESTIGATING THE SPREAD OF PATHOGENS AT A SITE

(71) Applicant: NSF International, Ann Arbor, MI (US)

(72) Inventors: Robert Scott Donofrio, Ypsilanti, MI (US); Kurtis Richard Kneen, Canton, MI (US); Peter John Langlais, Lakeville, MA (US); Sireesha Mandava, Westland, MI (US)

(73) Assignee: NSF International, Ann Arbor, MI (US)

(21) Appl. No.: 14/965,092

(22) Filed: Dec. 10, 2015

Related U.S. Application Data
(60) Provisional application No. 62/089,989, filed on Dec. 10, 2014.

(51) Int. Cl. G06F 19/00; G06F 17/30

(52) U.S. Cl. CPC G06F 19/3493; G06F 19/3443; G06F 19/3487; G06F 17/30572

(57) ABSTRACT

Systems and methods for investigating the spread of pathogens at a site are provided. Flow data indicating an identity and location of objects at the site and movement of the objects within the site over time is acquired. Sampling data indicating a presence of pathogens on the objects over time and an identity of pathogens that are present is acquired. A computing device receives and evaluates the flow data and the sampling data. Based on evaluating the flow data and the sampling data, the computing device generates a graphical indicator that is informative of movement of the identified pathogens within the site over time and is visually presented for display.

### CROSS-SECTION TO RELATED APPLICATIONS

The subject application claims the benefit of U.S. provisional patent application No. 62/089,989, filed on Dec. 10, 2014, the entirety of which is hereby incorporated by reference.

### TECHNICAL FIELD

The disclosure relates to systems, methods, and computer-readable storage media for investigating the spread of pathogens at a site. The suggested class/subclass of the disclosure is: CLASS 702/187 (DATA PROCESSING: MEASURING, CALIBRATING, OR TESTING/History logging or time stamping) and the suggested Art Unit is 2857.

### BACKGROUND

Infections are a leading cause of illness worldwide. Infections are caused by pathogens such as fungi, bacteria, and viruses, as well as other, less common infectious agents. Understanding the source and spread dynamics of such pathogens is critical to reducing infections. Conventional systems and methods for monitoring pathogens statically test for pathogens and do not provide forensic insight into pathogen dynamics, i.e., how and why such pathogens are physically spreading throughout the site. For example, conventional systems and methods are largely focused on simply monitoring compliance with existing protocols. Therefore, conventional techniques are limited in their ability to identify potential sources of such infections prophylactically and effectively.

### SUMMARY AND ADVANTAGES

One embodiment of a system for investigating the spread of pathogens at a site is provided. The system includes a computing device and a display in communication with the computing device. The computing device is configured to receive flow data indicating an identity and location of objects at the site and movement of objects within the site over time. The computing device is configured to receive sampling data indicating a presence of pathogens on the objects over time and an identity of pathogens that are present. The computing device evaluates the flow data and the sampling data. The computing device is configured to generate a graphical indicator based on the evaluation of the flow data and the sampling data. The graphical indicator is informative of movement of the identified pathogens with the site over time and is visually presented on the display.

One embodiment of a computer-implemented method for investigating the spread of pathogens at a site is also provided. A computing device and a display in communication with the computing device are utilized. The method comprises receiving flow data with the computing device. The flow data indicates an identity and location of objects at the site and movement of the objects within the site over time. The computing device receives sampling data indicating a presence of pathogens on the objects over time and an identity of pathogens that are present. The computing device evaluates the flow data and the sampling data. A graphical indicator is generated with the computing device based on the evaluation of the flow data and the sampling data. The graphical indicator is informative of movement of the identified pathogens within the site over time and is visually presented on the display.

One embodiment of a non-transitory computer-readable medium is provided. The non-transitory computer-readable medium has stored therein computer-readable instructions for a processor. The instructions when executed by the processor cause the processor to receive flow data indicating an identity and location of objects at the site and movement of the objects within the site over time and receive sampling data indicating a presence of pathogens on the objects over time and an identity of pathogens that are present. The instructions when executed by the processor cause the processor to evaluate the flow data and the sampling data and generate a graphical indicator based on evaluating the flow data and the sampling data. The graphical indicator is informative of movement of the identified pathogens within the site over time and is visually displayable.

The systems and methods advantageously track movement of the objects within the site over time and provide information about movement of identified pathogens within in a way that was never before possible and practical. By evaluating the flow data and sampling data over time, the computing device provides unprecedented in-depth analysis and forensic insight of the pathogen dynamics, i.e., how and why such pathogens are physically spreading or moving between objects throughout the site. This allows the system and method to prophylactically and effectively identify potential sources of such pathogens and actions for preventing, reducing, or eliminating such pathogens. Moreover, the system and method are able to the speciate infectious organisms using specialized identification and monitoring techniques and the use of specialized software to monitor, visualize and analyze trends in the site.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a flow diagram of a method for evaluating, monitoring, and preventing the spread of pathogens, according to one embodiment.

FIG. 2 is a flow diagram of a step for performing flow analysis, according to one aspect of the method.

FIG. 3 is a flow diagram of a step for collecting sampling data, according to one aspect of the method.

FIG. 4 is a flow diagram of a sampling plan, according to one aspect of the method.

FIG. 5 is a flow diagram of a step for generating the sampling plan according to one aspect of the method.

FIG. 6 is a flow diagram of a step for evaluating and displaying inputted flow data and sample data with a computer executable program, according to one aspect of the method.

FIG. 7 is a layout of a network that includes a computer in communication with a server through the network, according to one embodiment.

FIG. 8 is a system layout of the network, which hosts the computer executable program on the server, according to one embodiment.

FIG. 9 is a system layout of the network, which hosts the computer executable program on the computer in communication with the server, according to one embodiment.

FIG. 10 is a system layout of the network, according to one embodiment.

FIG. 11 is a system layout of the network, according to another embodiment.

FIG. 12 is a flow diagram of a step for inputting data into the computer executable program, according to one aspect of the method.

FIG. 13 is a flow diagram of a step for identifying trends in inputted data with the computer executable program, according to one aspect of the method.

FIG. 14 is a flow diagram of a step for identifying trends in multiple sets of inputted data with the computer executable program, according to one aspect of the method.

FIG. 15 is a flow diagram of a step for accessing the computer executable program with a web browser, according to one aspect of the method.

FIG. 16 is a flow diagram of a step for accessing the computer executable program with a login identity, according to one aspect of the method.

FIG. 17 is a sample screen shot of the computer executable program displaying visual representations of evaluated data in a graphical user interface, according to one embodiment.

FIG. 18 is a flow diagram of the program displaying visual representations of evaluated data in the graphical user interface based on electronic selections, according to one embodiment.

FIG. 19 is a sample screen shot of the program displaying related flow data and sample data at the same time in the graphical user interface, according to one embodiment.

FIG. 20 is a sample screen shot of the program displaying trends in the graphical user interface, according to one embodiment.

FIG. 21 is a sample screen shot of the program displaying positive counts generated from the sample data in the graphical user interface, according to one embodiment.

FIG. 22 is a sample screen shot of the program displaying alerts generated from the evaluated data in the graphical user interface, according to one embodiment.

FIG. 23 is a sample screen shot of the program displaying data in a dashboard in the graphical user interface, according to one embodiment.

FIG. 24 is a flow diagram of a step for selecting corrective actions according to one aspect of the method.

FIG. 25 is a flow diagram of a step for validating corrective actions according to one aspect of the method.

FIG. 26 is a flow diagram of a step for selecting and validating corrective actions according to one aspect of the method.

FIG. 27 is an example of a virtual representation of the site, e.g., a hospital unit, that is provided by the computing device.

FIG. 28 is an example of graphical indicators, such as a pathogen source indicator and pathogen path of movement indictor, being overlaid on the virtual representation of the site of FIG. 27.

### DETAILED DESCRIPTION

Referring to the Figures, wherein like numerals indicate like or corresponding parts throughout the several views, systems and methods for evaluating, monitoring, and preventing the spread of pathogens are shown.

I. Overview

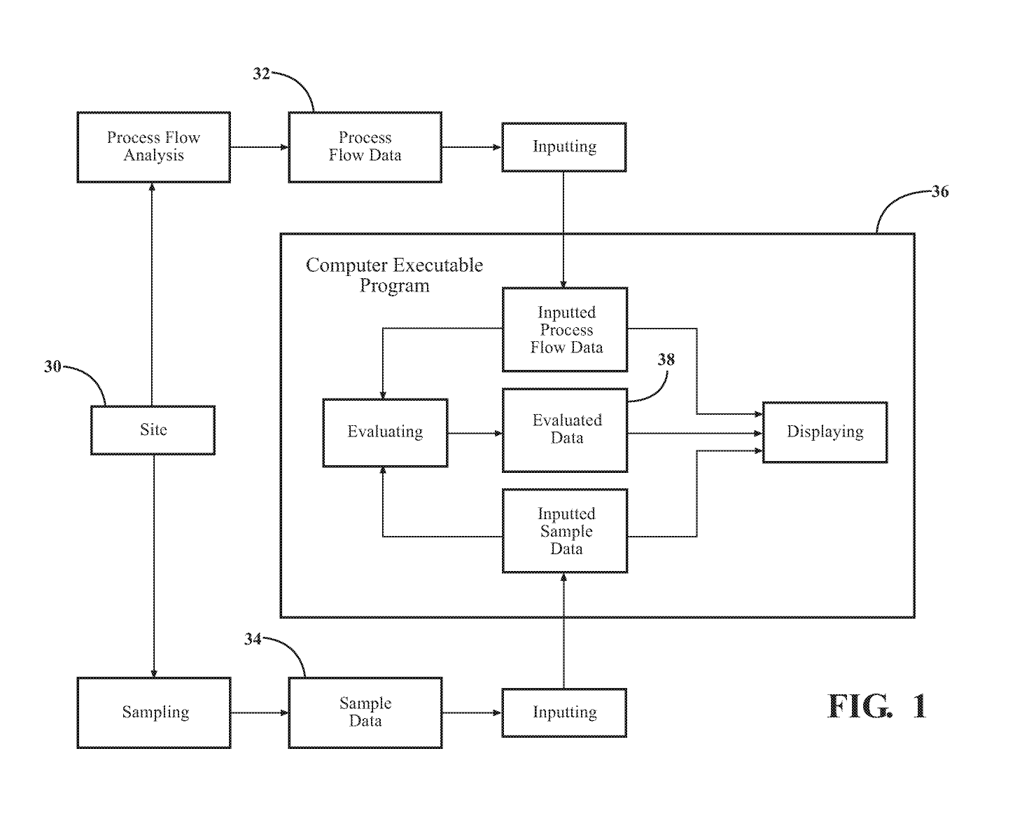

As shown in FIG. 1, the system and method for evaluating, monitoring, and mitigating the spread of pathogens at a site 30 are provided. Flow analysis is performed at the site 30 relative to objects at the site 30 to generate flow data 32. The site 30 is sampled to generate sampling data 34. The flow data 32 and the sampling data 34 are electronically inputted into a computer executable program 36 (hereinafter referred to as “program”). The program may 36 comprise code or instructions that are storable on a non-transitory computer-readable medium such that a processor can execute the code or instructions to cause the processor to perform the desired operations of the program 36. The program 36 evaluates the flow data 32 and electronically generates evaluated data 38. The program 36 instructs the display of the evaluated data 38.

The system and method may be provided as a service offering that focuses on monitoring the cleaning practices at any appropriate site, such as in a health care facility, as well as determining the sanitation efficacy on various surfaces at the site. The system and method may be utilized as a monitoring and diagnosis program. The system and method may provide feedback on sanitation efficiency, staff adherence to the specified cleaning protocol and may bring well-needed attention to surfaces and areas within the site 30 being monitored that are insufficiently cleaned or that could serve as potential health risks for pathogens, such as HAIs (hospital associated infection producing microorganisms).

The system and method may be implemented with an offering providing multiple levels of service including 1) site and flow assessment, 2) customized monitoring and sampling plan, 3) onsite sampling, 4) cleanliness monitoring, and 5) data management and reporting. The site and flow assessment is a site evaluation of object dynamics at the site. The customized monitoring and sampling plan is developed based on at least the site and flow assessment. Furthermore, onsite sampling on identified surfaces, materials, devices and water sources, and the like may be performed. One function of this phase is to determine the reservoirs of infectious agents within the site. Identifying such affected sources allows staff to focus on remediation of the sources. Other levels of service may include cleanliness monitoring, data reporting, and client interface including statistical correlation of pathogen occurrence to sanitation performance. These examples of service offerings are provided for illustrative purposes to describe the context surrounding the system and method.

II. Site

The site 30 may be virtually any location, place, establishment, institution, venue, business, and/or scene where pathogens may exist. The site 30 may be public or private. The site 30 may be stationary or mobile. The site 30 may relate to healthcare. For example, the site 30 may be a hospital, clinic, urgent care or surgical center, day care facility, ambulatory setting, rehabilitation facility, nursing home, long term care facilities and the like. The site 30 may relate to public forums, such as, but not limited to, airports, city streets, parks, town squares, educational facilities (K-12 schools), and the like. The site 30 may relate to any hospitality or entertainment venue, such as, but not limited to, stadiums, shopping malls, theme parks, zoos, theaters, and the like. Other examples of the site 30 include, but are not limited to, a workplace, a place of worship, a store, a hotel, a motel, a place of residence, a restaurant, and the like. Examples of mobile sites 30 include moving vehicles, such as aircrafts, boats, barges, cruise ships, vessels, buses, trains, automobiles, rail systems, entertainment attractions, elevator or escalator systems, and the like.

The site 30 includes a layout that may be defined according to any suitable method. The layout may be defined by the location of objects at the site 30. For example, the layout may be defined by buildings, departments, sections, subdivisions, sectors, floors, levels, rooms, areas, fixtures, and any combinations thereof, at the site 30. For example, the layout of a healthcare facility may include admission, emergency room, intensive care unit, oncology, pediatric, and radiology departments. In another example, the layout of a cruise ship may include pool area, dining area, entertainment area, and the like. Examples of fixtures may include any whole, or part of, an appendage, apparatus, or appliance attached to any part of the site 30, such as, but not limited to, doors, door knobs, doorplates, HVAC control panels, light switches, sinks, showers, toilets, toilet handles, toilet seats, shower curtains, shower heads, faucets, drainage plates, and pipes.

III. Site and Flow Analysis

One of the initial steps in the process is performing a flow analysis. The flow analysis is used to produce flow data indicating an identity and location of objects at the site and movement of the objects within the site over time. The flow analysis is important to fully understand the flow of objects, such as patients, hospital staff, guests, equipment, and supplies. The focus of the investigation may be on high touch or frequent touch areas within the site 30. The flow analysis also provides an opportunity to inspect potential sources of contamination from environmental sources (air, water). In a hospital setting, for example, the assessment may be conducted with the assistance of the infection preventionist (IP), medical director (MD) and environmental services manager (ES) of the hospital. The flow analysis is described in detail below.

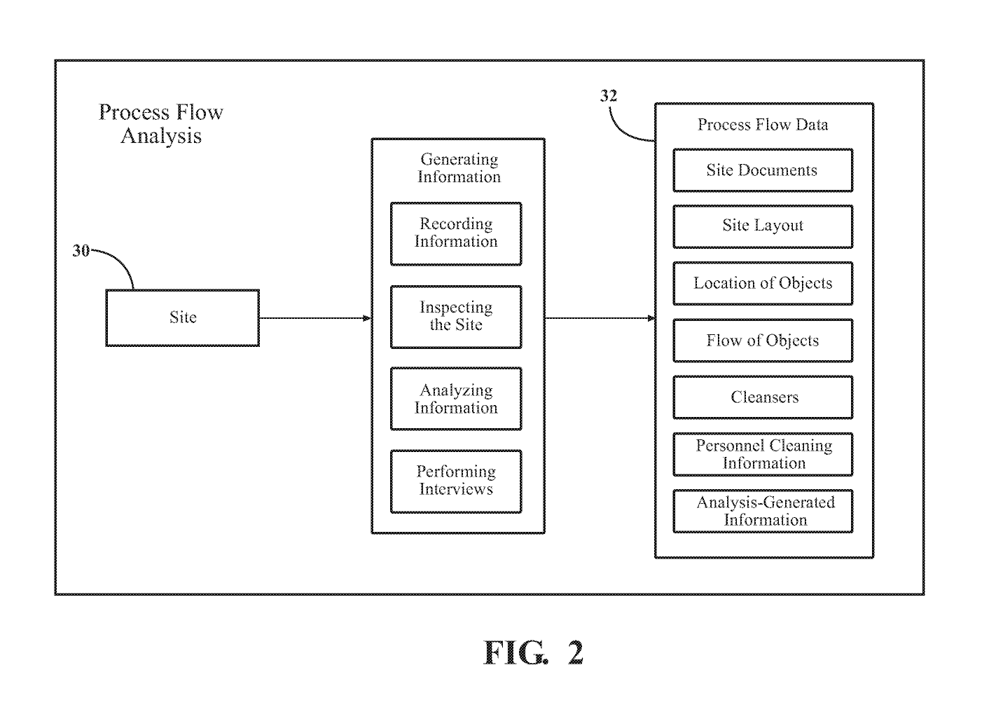

As shown in FIG. 2, flow data 32 about the site 30 includes information about the site 30 generated during performance of flow analysis. Information is generated during performance of the flow analysis by determining and recording information about the site 30, as described in further detail below. Information may be recorded by methods including electronic recording, non-electronic recording, or combinations thereof. Flow data 32 also includes documents of the site 30, such as, but not limited to, reports, instructions, audits, inventories, logs, schedules, and pictures.

a. Layout of the Site

Generating flow data 32 about the site 30 includes determining a layout of the site 30. Determining the layout of the site 30 may include inspecting and recording the locations of rooms, areas, departments, floors, and buildings of the site 30. Determining the layout of the site 30 may also include analyzing documents containing information regarding the layout of the site 30, such as, but not limited to, blue-prints and pictures, and recording the information therein. Determining the layout of the site 30 may further include investigating persons associated with the site 30, such as staff and visitors, to produce information concerning the layout of the site 30. The information concerning the layout of the site 30 may be recorded to generate flow data 32.

Ultimately, the program 36 may determine a virtual representation, layout or floor plan of the site 30 based on, for example, the flow data 32. The virtual layout of the site 30 is a computer-based representation of the real layout of the site 30, including the objects and positioning of objects within the site 30. The virtual layout may be a 2-dimensional or 3-dimensional model, for example. As described below, the virtual layout is utilized to help monitor and visualize the spread of pathogens at the site 30. Any of the methods described herein in relation to the real layout of the site 30 may be implemented using the virtual layout of the site 30.

b. Location of Objects at the Site

Generating flow data 32 about the site 30 may also include determining a location, position, and/or flow of movement of objects in relation to the layout of the site 30. Objects may include inanimate objects or living objects. For example, the objects may include persons, equipment, items, and food. Examples of persons associated with the site 30 may include, but are not to, staff, visitors, licensees, invitees, trespassers, and the like. Examples of equipment may include articles at the site 30, such as, but not limited to, monitors, medical machines, medicine holders, medical tools, bedpans, call boxes, soap dispensers, sanitizer dispensers, HVAC systems, and pieces associated with any of the articles thereof. Examples of items may include furniture at the site 30, such as, but not limited to, tables, beds, chairs, couches, televisions, and lamps, and cleaning supplies, such as, but not limited to, mops, brooms, buckets, and brushes. Examples of items may also include telephones, remote controls, and window dressings. Examples of food may include any substance ingested by an organism to provide energy, maintain life, or stimulate growth, such as, but not limited to, fats, proteins, carbohydrates, fibers, vitamins, minerals, and mixtures thereof. The list of objects, persons, equipment, items, and food presented herein are representative. Those having skill in the art appreciate that data about other objects, persons, equipment, items, and food may be utilized in generating flow data 32 about the site 30.

Determining the location of objects in relation to the layout of the site 30 may include interviewing persons associated with the site 30 to ascertain information regarding the location of objects in relation to the layout of the site 30. Determining location of objects in relation to the layout of the site 30 may also include inspecting and recording the locations of objects within rooms, areas, departments, floors, or buildings of the site 30. Determining the location of objects in relation to the layout of the site 30 may further include analyzing documents containing information regarding the location of objects in relation to the layout of the site 30, such as, but not limited to, reports, instructions, audits, inventories, logs, schedules, and pictures, and recording the information therein.

c. Flow of Objects Throughout the Site

Generating flow data 32 about the site 30 may also include determining the flow of objects throughout the layout of the site 30. In other words, such flow data 32 relates to when, how, where, and why objects move from one location to another within the site 30. The flow data 32 may also define what individuals move the objects. The flow of the objects may include the change in the location of the objects in relation to the layout of the site 30 over a period of time. Examples of the period of time include, but are not limited to, one day, one week, one month, and one year.

Determining the flow of objects throughout the layout of the site 30 may include inspecting and recording the flow of objects within rooms, areas, departments, floors, and buildings of the site 30. Determining the flow of objects throughout the site 30 may also include analyzing documents containing information regarding the flow of objects throughout the site 30, such as, but not limited to, reports, instructions, audits, inventories, logs, schedules, and pictures, and recording the information therein. Determining the flow of objects throughout the layout of the site 30 may further include interviewing persons associated with the site 30 to produce information concerning the flow of objects throughout the layout of the site 30. The information concerning the flow of objects throughout the layout of the site 30 may then be recorded to generate flow data 32. Additionally, tracking movement of the object may include tracking the flow of air at the site 30.

Flow data 32 may relate to patient flow throughout the site 30. Such data may include, for example, identification of rooms occupied by patients who became infected, identification of rooms where invasive procedures are performed. Flow data 32 may relate to staff flow throughout the site 30. Such data may include, for example, movement of staff within the site 30 who would have contact with the infected patients or potentially contaminated equipment/supplies, identity of hand wash or disinfection stations designated to be used by such staff, and the like. Flow data 32 may relate to visitor flow throughout the site 30. Such flow data 32 may include, for example, identification of movement of patient visitor's within the site 30 who would have contact with the infected patients or potentially contaminated equipment/supplies, identification of hand wash or disinfection stations designated to be used by such visitors, identification of waiting areas and objects/surfaces within the waiting area that are frequent touch areas, and the like. Flow data 32 may also relate to equipment flow throughout the site 30. Such data may include, but is not limited to, identification of equipment movement throughout the site, identification of equipment used in invasive procedures, identification of equipment name or serial number, tracking of where (e.g., room or location) equipment is stored, identification of areas used in the cleaning and disinfection of the equipment, identification of surfaces or locations within the site where equipment is stored pre and post disinfection, identification of disinfection/sterilization procedures. Flow data 32 relating to equipment flow may be based on review of disinfection/sterilization records or review of disinfection/sterilization procedure validation, or the like.

d. Environmental Condition Sources

Generating flow data 32 about the site 30 may also include determining information about environmental condition sources. In one example, the flow data 32 relating to environmental condition sources includes an identification of water sources within the site 30 that may potentially come into contact with patients, staff, visiting guests or equipment (i.e. used to wash hands, rinse equipment, or the like. To facilitate such identification, available water quality reports (specifically for bacterial contamination) or maintenance events records may be reviewed. Additionally, eye wash stations may be identified because such eye wash stations are attached to the faucet and may be an ideal reservoir for biofilms.

Numerous other environmental condition sources may be evaluated to generate flow data 32. For example, a location of hand sanitizers and hand wash stations may be identified by techniques, such as, but not limited to reviewing records of hand wash station maintenance, or the like. Air sources for rooms may also be identified and inspected by techniques, such as reviewing air quality records, or the like. Carts or mobile cabinets that carry equipment and supplies may be identified using techniques, such as reviewing records of cart disinfection, or the like. Local surface disinfection devices (i.e. UV lamps) may be identified using techniques, such as inspecting maintenance logs to verify that such devices are functioning correctly and have been initially qualified for use.

IP, MS and ES recommended surfaces may be evaluated to generate flow data 32. For example, based on experience and knowledge of the facility and flow, the IP, MS and ES may suggest additional surfaces, objects or locations to include in the microbiological site survey. Such recommended surfaces, objects or locations may be noted by specifying in what room(s) the items are located, and who made the request to add the object to the sampling plan.

CDC recommended high touch surfaces may be evaluated to generate flow data 32. The CDC has recommended a number of items and surfaces within the patient zone to be included for cleaning and monitoring, based on published information relating to the contamination of these surfaces with healthcare-associated pathogens. The CDC also provides suggestions about the likelihood that such items and surfaces will be touched during routine care by healthcare personnel without changing their gloves or performing hand hygiene prior to touching or using these items. The CDC recommended surfaces and objects should be considered for inclusion in the microbiological survey and are as follows (notably not all sites will possess these items): bed rails (if the bed rail has bed controls, evaluate the control area; if not, evaluate on the smooth inner surface); tray tables (evaluate the top of the tray); telephones (evaluate the back side of the hand held portion of the telephone near the top of the phone, away from the end that is attached to the phone wire); bedside tables (evaluate the drawer pull); patient chair (evaluate the center of the seat of the chair close to the rear of the cushion; if the cushion is covered in textured fabric, evaluate the arm of the chair); sinks (evaluate the faucet handles and within the effluent end of the faucet; if eye wash station present or affixed to the faucet system, disassemble and swab internal surfaces; collect a water sample); bathroom and patient room light switches (evaluate the switch and whole plate); door knobs, push plates and door levers (evaluate inside door knobs and levers; for round door knobs, sample entire face of the knob; for levers, sample entire surface there hand would grasp; for push plates, evaluate the entire face of the push plate); toilet area hand holds and bathroom handrails (evaluate the entire surface of the hand rail); toilet seats (evaluate the entire surface of the toilet seat); toilet handles (evaluate the entire surface of the handle); bed pan cleaning equipment (for hinged pipe type cleaners, evaluate the spray head; for spray hoses evaluate the entire surface of the handle that is used to activate the spray head); IV pump control panel (evaluate the portion of the panel that is most frequently touched by the healthcare providers); monitoring control panel (evaluate the entire surface of the control area); monitor touch screen (evaluate the entire surface of the touch screen); monitor cables (evaluate the junction box area); and ventilator control panel (evaluate the entire panel). Those skilled in the art appreciate that various other objects may be evaluated depending on the specific site 30. Furthermore, the evaluation techniques may be different than those described herein. The evaluation techniques may be utilized to generate sampling data 34, as described in detail below. Moreover, the following objects may be evaluated using any suitable technological measures, including, mobile devices that can communicate with the computing device or the like.

e. Cleaning Data

Generating flow data 32 about the site 30 may also include determining cleaning data indicating when, where, how, or why cleansers were used at the site 30. The cleaning data may include information about one or a plurality of cleansers used at the site 30. The cleansers may include, but are not limited to, detergents, surfactants, sterilizers, disinfectants, decontaminators, antimicrobials, enzymatics, and formulations thereof. Information about the cleansers may include, but is not limited to, the type, brand name, lot number, expiration date, storage location, usage dates, usage location, active ingredients, manufacturer, and combinations thereof. Information about the cleansers may also include the protocols and procedures associated with using the cleansers at the site 30.

Determining information about the cleansers used at the site 30 may include inspecting the site 30 to identify information concerning the cleansers, and recording any identified information about the cleansers. Determining information about the cleansers used at the site 30 may also include analyzing documents containing information concerning the cleansers and recording the information therein. Examples of such documents may include, but are not limited to, reports, instructions, audits, inventories, logs, schedules, and pictures. Determining information about the cleansers may further include interviewing persons associated with the site 30 to produce information concerning the cleansers used at the site 30. The cleaning data may be directly related to objects at the site 30. The cleaning data may also include an identification of whom (e.g., staff member name or shifts) used the cleanser. The information concerning the cleansers used at the site 30 may then be recorded to generate flow data 32.

Cleaning information about the site 30 may include, but is not limited to, the identity of any part of the site 30 cleaned, the identity of objects cleaned at the site 30, the methods used to clean the objects in, and parts of, the site 30, the dates and times of the cleanings performed at the site 30, the identity of personnel who performed the cleanings at the site 30, and any combinations thereof. Examples of cleaning information about the site 30 may include, but are not limited to, cooking food.

Determining cleaning information about the site 30 may include inspecting the site 30 and recording any cleaning information about the site 30 identified during the inspection. Determining cleaning information about the site 30 may also include analyzing documents containing information concerning any cleaning information about the site 30 and recording the information therein. Examples of such documents may include, but are not limited to, reports, instructions, audits, inventories, logs, schedules, recipes, and pictures. Determining cleaning information about the site 30 may further include interviewing persons associated with the site 30 to produce cleaning information about the site 30. The cleaning information about the site 30 may then be recorded to generate flow data 32.

Cleaning data may be based on past information or current cleaning information. In a hospital setting, for example, the following cleaning information may be obtained by reviewing previous environmental testing reports (if available), reviewing previous internal and external audit findings that might affect HAI occurrence (i.e. improper hand washing, unsanitary practices, inappropriate disinfection preparation or use, staff training issues), or the like.

f. Generating Information Through Analysis

The information generated during performance of the flow analysis may be analyzed to generate new information about the site 30. Analyzing the information generated during performance of the flow analysis may include, but is not limited to, compiling, manipulating, organizing, or formatting the information, or any combinations thereof.

Flow data 32 may be generated with the program 36. Also, as described in detail below, the program 36 analyzes the information generated during performance of the flow analysis.

In one embodiment, more than one flow analysis may be performed on the site 30. A flow data set is generated each time the flow analysis is performed on the site 30. The flow data set includes all of the flow data 32 generated during one flow analysis of the site 30. More than one flow data set may be generated by performing flow analysis on the site 30 more than once.

The examples of information gathered in generating processes flow data 32 as described herein are representative. Those having skill in the art appreciate that flow data 32 about the site 30 may be generated from other resources related to the site 30 not described herein. Additionally, the flow data 32 may be electronically or manually generated.

IV. Sampling

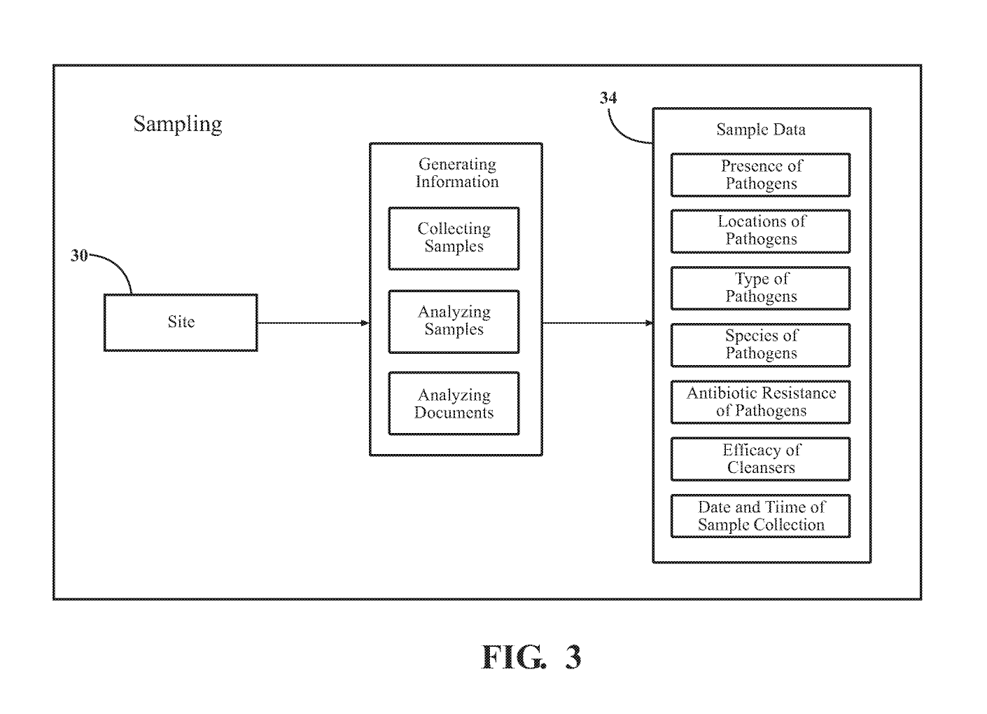

Sampling the site 30 includes collecting and analyzing samples from the site 30. As shown in FIG. 3, sampling the site 30 is performed to generate sampling data 34. The computing device is configured to receive sampling data indicating a presence of pathogens on the objects over time and an identity of pathogens that are present.

Sampling data 34 may include the efficacy of cleanser used at the site 30. Sampling data 34 may be used to analyze the validity of protocols and procedures for using the cleanser in site 30. As also shown in FIG. 3, sampling data 34 may include a date and time at which sampling data 34 was generated.

Sampling data 34 may further include information concerning pathogens at the site 30. As used herein, the term “pathogen” refers to a microorganism which can cause disease in its host. The term “pathogen” typically describes an infectious agent (colloquially known as a germ). Examples of pathogens may include, but are not limited to, bacteria, viruses, fungi, prions, and combinations thereof. The host may be an animal, a plant, a fungus or even another microorganism. The pathogens may be spread by animal or non-animal actions. For example, the pathogens at the site 30 may be spread by human (or other animal) interaction. Additionally, the pathogens may be foodborne. Pathogens may also spread through the air by way of an HVAC system. Those skilled in the art appreciate that pathogens may spread in various other ways not specifically described herein.

One focus for the system and method is the mitigation of healthcare-associated infections (HAIs), which are infections associated with the devices used in medical procedures, such as catheters or ventilators. Modern healthcare employs many types of invasive devices and procedures to treat patients and to help them recover. HAIs include central line-associated bloodstream infections, catheter-associated urinary tract infections, and ventilator-associated pneumonia. Infections may also occur at surgery sites, known as surgical site infections. Common HAIs include HAI Bacteria, Acinetobacter, Burkholderia cepacia, Clostridium difficile, Clostridium Sordellii, Enterobacteriaceae (carbapenem-resistance), Klebsiella, Methicillin-resistant Staphylococcus aureus (MRSA), Mycobacterium abscessus, Pseudomonas aeruginosa, Staphylococcus aureus, Tuberculosis (TB), Vancomycin-intermediate Staphylococcus aureus and Vancomycin-resistant Staphylococcus aureus, Vancomycin-resistant Enterococci (VRE), HAI Virus, Human Immunodeficiency Virus (HIV/AIDS), Influenza, Hepatitis, Norovirus, and the like.

Examples of information concerning pathogens may include, but are not limited to, the location, type, species, antibiotic resistance profile, staining profile, or treatment profile, of any pathogen at the site 30. Information concerning pathogens at the site 30 may also include the absence of any pathogens from locations at the site 30.

Sampling data 34 may be generated by collecting and analyzing samples from the site 30. Collecting samples from the site 30 may be completed by using methods such as, but not limited to, swab sampling, water source sampling, direct item sampling, and air sampling. Samples of the site 30 may include samples collected from surfaces, objects, water, and air at the site 30.

Analyzing samples collected from the site 30 includes detecting the presence of pathogens within or on the samples. Whenever the presence of pathogens is detected within or on one of the samples, a positive count is generated. Detecting the presence of pathogens within or on the samples may include detecting the presence of biomolecules within or on the samples, such as, but not limited to, adenosine triphosphate (ATP). Detecting the presence of biomolecules within or on an individual sample may be used to determine a positive presence of a pathogen within or on the individual sample. Detecting the presence of any pathogen within or on any of the samples may be performed using hand-held devices. Examples of hand-held devices may include, but are not limited to, a Ruhof ATP Complete®, a PROFILE® 1 Bioluminometer, and a SystemSURE® Hygiene Monitor Device.

Based on the collected samples, information concerning the pathogens is determined by analyzing the samples. Analyzing samples may be completed using analytical methods such as, but not limited to, luminescence spectroscopy, infrared and Raman spectroscopy, nuclear magnetic resonance spectroscopy, mass spectrometry, gas chromatography, high performance liquid chromatography, electrophoreses, metabolic fingerprinting, DNA sequencing, staining, and selective media plating. Examples of analytical methods may include, but are not limited to, ATP-luciferase luminometry, MALDI-TOF mass spectrometry.

The sampling data 34 is indicative, at some level, of the species or genus of the pathogen. The sampling data 34 may be any suitable bio-marker useable across any genus, sub-genus, or species. This way, the sampling data 34 can identify the pathogens by genus, sub-genus, or species, for more effective and investigation.

Sampling data 34 may also be generated by analyzing documents from the site 30, such as, but not limited to, reports, instructions, audits, inventories, logs, schedules, and investigations concerning pathogens at the site 30. Sampling the site 30 may be performed more than once. A sample data set is generated each time the site 30 is sampled. The sample data set includes the sampling data 34 generated during one sampling of the site 30. More than one sample data set may be generated by sampling the site 30 more than once.

The sampling data 34 may be historical or present information. For example, when the site 30 is a hospital, the following sampling data 34 may be obtained: HAI strain profile information, if available, including but not limited to antimicrobial sensitivity profiles; available DNA sequence data; biochemical and metabolic profiles; conditions used by laboratory for culturing HAI (media, incubation conditions), and the like. Additionally, sampling data 34 may include HAI(s) of concern for the particular project/client/site, identification of location of the affected hospital facility, history of a particular HAI issue at the hospital facility (i.e. # of patients affected, frequency of infections, how long has this HAI been an issue at this facility), or the like.

The examples of information gathered in generating sampling data 34 as described herein are representative. Those having skill in the art appreciate that sampling data 34 about the site 30 may be generated from other resources related to the site 30 not described herein. Additionally, sampling data 34 may be electronically or manually generated.

a. Sampling Plan

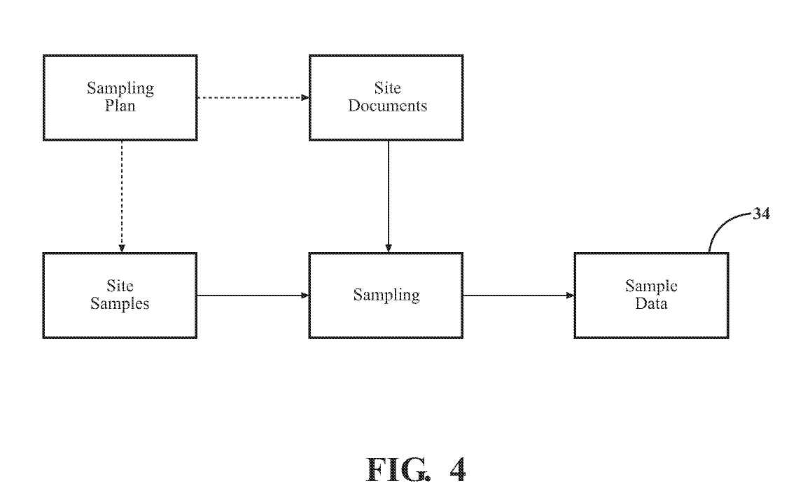

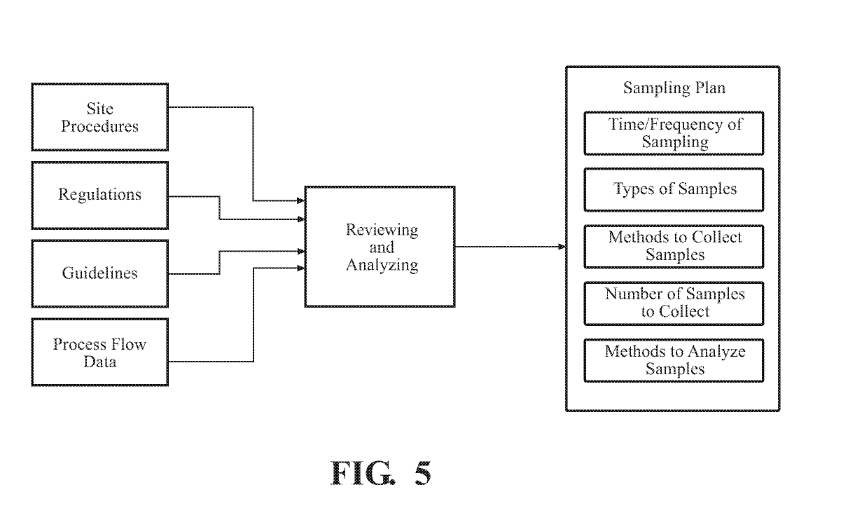

Following completion of the site assessment, a monitoring and sample plan may be designed. As shown in FIG. 4, sampling the site 30 may be performed according to the sampling plan. The sampling plan may provide an outline of processes and instructions for sampling the site 30. As shown in FIG. 5, the sampling plan may include information specifying the type of samples to be collected during sampling, methods for collecting the samples, methods for analyzing the collected samples, sampling frequency, and combinations thereof. Generating the sampling plan may include, but is not limited to, reviewing and analyzing guidelines from one or more regulatory or standard setting organizations, the flow data 32 generated from the flow analysis, safety programs, procedures and protocols used at the site 30, or combinations thereof. Examples of regulatory and standard setting organizations may include, but are not limited to, the Centers for Disease Control and Prevention (CDC), the World Health Organization (WHO), the International Organization for Standardization (ISO), the National Institute of Standards and Technology (NIST), the United States Department of Labor Occupational Safety & Health Administration, and the United States Food and Drug Administration (FDA). Examples of guidelines known in the art may include, but are not limited to, Hazard Analysis and Critical Control Points (HACCP). In other examples, additional data capture modules may be added to the sampling plan, including, capturing data relating to hand washing, antimicrobial stewardship initiatives, and the like.

The sample plan may include the following: schematic or diagram of the floor plan of the hospital ward or facility designated for sampling (each room individually identified with a unique identifier); a list of items, surfaces and samples that will be included in the sampling regimen (the list specifying a detailed location of each sample (including room name)); and a list of laboratory tests that each individual sample will be subjected to (this list should reference established Beaker (LIMS) test codes).

The following sampling acquisition procedures may be implemented in the sampling plan: grab samples (for water samples, disposal fittings, etc.); rinsates (for duodenoscopes and endoscopes, brushes, etc); surface samples (via swabs, sponges, surface contact plate, etc.); air samples (via impactor, settling plate, etc); ATP (adenosine triphosphate) swabs; and technology (including, but not limited to, sensors, direct pathogen detection systems, or the like). For example, the program 36 may incorporate sensors placed within or on objects (e.g., on surfaces, clothing, bedding, etc) designed to detect single cells of pathogens. Additionally or alternatively, the program 36 may link data from sensors designed to monitor the actions and behavior (e.g., washing of hands) by staff, visitors and patients, or the like.

The obtained samples may be evaluated for the indicators of microbial contamination and/or pathogens. This may include: heterotrophic bacteria, yeast and mold, coliforms, anaerobic bacteria, ATP, HAIs, emerging pathogens or indicators, or the like.

Technology employed for organism and metabolite evaluation may include, but is not limited to: direct plating on non-selective and selective media, biochemical profiling, antimicrobial resistance profiling, molecular sequencing, ELISA, chemical analysis via MALDI-TOF mass spectroscopy, GC-FID, LCMS, ATP-luciferase luminometry, or the like.

In one proposal, ATP samples may be taken daily by trained healthcare staff. Other microorganism and biochemical indicator samples may be, for example, obtained on a weekly basis. For each event, a percentage, e.g., 10% of the site rooms may be sampled. The rooms may be rotated on a weekly basis so that all rooms are covered during the monitoring process.

b. Monitoring Plan

The program 36 is configured to construct a monitoring plan. The monitoring plan may include the following: virtual schematic or diagram of the floor plan of the hospital ward or facility designated for sampling (each room should be individually identified and have a unique identifier); a list of items, surfaces and samples to be included in the sampling regimen (the list specifying a detailed location of each sample (including room name)); a list of laboratory tests that each individual sample will be subjected to (this list should reference established Beaker (LIMS) test codes). The monitoring plan may include cleaning data such as room cleaning event data, including, but not limited to identification of the room being cleaned; identification of the individual(s) responsible for cleaning the room; date/time of initiating room cleaning; date/time of finishing room cleaning; cleaner/sanitizer system(s) used (manufacturer, lot, dilution (yes/no), preparation date, expiration date, etc.); identification of the hospital's cleaning protocol that was followed protocol followed, and the like.

All cleaning events that occur for the rooms covered under this monitoring plan will be tracked and entered. Data for the cleaning monitoring will be entered by a trained healthcare staff member.

The sampling plan and/or monitoring plan may be shared internally with the microbiology lab as well as the technical project manager of the service provider. The microbiology lab may utilize the information to assemble a sampling kit for the specialist. The sampling kit will be described in the following section. The specialist may arrange for a conference call with the hospital contact (most likely the IP) to discuss the sampling plan. The discussion should include review of the sample locations, discussion of client staff that will be involved and their availability (to ensure access to the sample locations) and a review of the proposed sample acquisition flow.

c. Pre-Site Visit Preparation and Sampling Kit

Prior to visiting the site to perform sampling, the microbiology lab may assemble a sample kit. The kit may contain the following: cooler; sets of gloves; writing utensils; Chain of Custody form; alcohol pads; spray bottle with 70% isopropyl alcohol (for hand disinfection); print-out of facility schematic, indicating probable locations of samples; garbage bag (medium); pairs of shoe covers; masks; ruler; roll of sample tamper indication tape (to affix to water bottles and whirlpak bags over the seal); ice packs (frozen; need adequate number of ice packs to maintain an internal transport temperature of 4° C.); temperature probe (to monitor temperature throughout sampling and transport). If surface samples are to be obtained, the kit may further comprise validated swabs or sponges with neutralizer or direct surface contact plates. If water samples are to be obtained the kit may comprise 250 ml Nalco sample bottles (or equivalent) with caps and sodium thiosulfate (neutralizer for chlorinate tap water); Parafilm (to seal the water bottles); and sample tape (to cover parafilm on the cap seal). If rinse samples are to be obtained, the kit may comprise lock fitted syringes (50 or 100 cc); neutralizer solution (volume to be dictated by sampling plan); and 150 ml sample bottles (or equivalent) with caps. If ATP samples are to be obtained, the kit may comprise an ATP meter and sufficient ATP swabs to samples all designated surfaces. If individual items are to be obtained, the kit may comprise whirlpak bags. The sample plan may indicate if any larger objects are to be sampled or retained for processing. In such instances, the bag size should be adjusted based on the sampling plan.

For the sample bottles, bags and swabs, the kit may provide several extra of each in case additional sampling is requested by the client while onsite. The sample kit will be provided to the service provider on-site specialist, who should also bring the following to the site visit: source of identification; business cards; camera; project notebook; and copy of signed contract.

The specialist, once on site, should confirm and adhere to any sign-in and security requirements of the hospital or care center. The specialist should review the sample plan prior to the onsite visit with the client. Sample acquisition should be as efficient as possible or practical so as to limit the time that normal work flow at the client's site is impaired. The specialist may take digital photographs or videos of the sample locations and sample items.

d. Sample Transport, Relinquishment, and Retention

The samples are preferably transported to the microbiology laboratory within 24 hours of the sampling event. If the timing of the sample acquisition prevents same day return to the laboratory, the cooler should be placed in a refrigerator overnight until transport to the lab the next morning. If the samples are to be shipped back to the lab, an appropriate hub must be identified to avoid shipping potential biohazards. The cooler must be shipped as a Category B (UN 3373) environmental sample and should be shipped as “Priority Overnight”. A designated laboratory recipient from the microbiology lab should be indicated on the shipping forms. The specialist completes the “Released By” section of the Chain of Custody at this time. The specialist should notify the microbiology lab recipient of the tracking number once the package has been shipped. The specialist may deliver the sample cooler directly to a designated laboratory recipient within the microbiology lab. The specialist completes the “Released By” section of the Chain of Custody at this time. Alternatively, if the sample cooler was shipped, sample management can receive the cooler and deliver to the designated microbiology lab recipient. The “Received By” section of the COC will be completed at this time. Testing will then commence within the lab.

The microbiology laboratory should following sample processing including for example: swabs/sponges (1 month following data entry into the program 36; kept at 4° C.); surface contact plates (2 weeks following data entry into the program 36; kept at 4° C.); residual water sample, if available (1 month following data entry into the program 36; kept at 4° C.); residual rinsate sample, if available (1 month following data entry into the program 36; kept at 4° C.); collected items, designated by the client as non-disposable and to be returned (sterilize per directions of client and return within 2 weeks of issuing of final report); media plates containing target isolates (1 month following data entry into the program 36; kept at 4° C.); media plates containing non-target isolates (2 weeks following data entry into the program 36; kept at 4° C.); and freezer stock suspensions of the isolated target HAI (3 replicates prepared for storage; kept at −70° C. for minimum 1 year following data entry into the program 36).

Retained organism stocks may be used in validating current or alternative cleaning and disinfection protocols. These studies are carried out within the microbiology labs and follow validated microbial efficacy evaluation protocols (i.e. AOAC, ISO, etc).

V. Computer Executable Program and Network

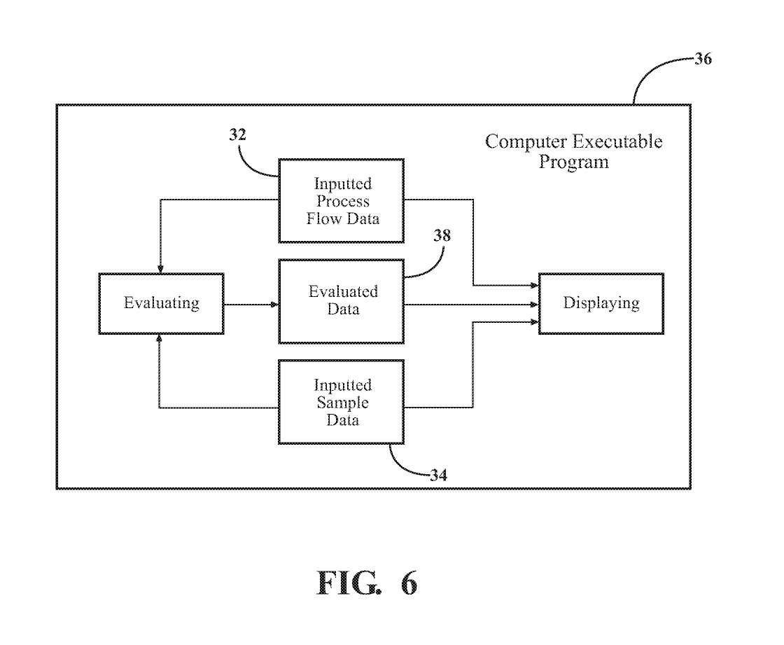

As shown in FIG. 6, the program 36 is configured to electronically receive inputted flow data 32, sampling data 34, or both. The program 36 is also configured to electronically evaluate inputted flow data 32 and sampling data 34. The program 36 is further configured to electronically generate evaluated data 38 by evaluating inputted flow data 32 and sampling data 34. The program 36 is additionally configured to electronically display the evaluated data 38.

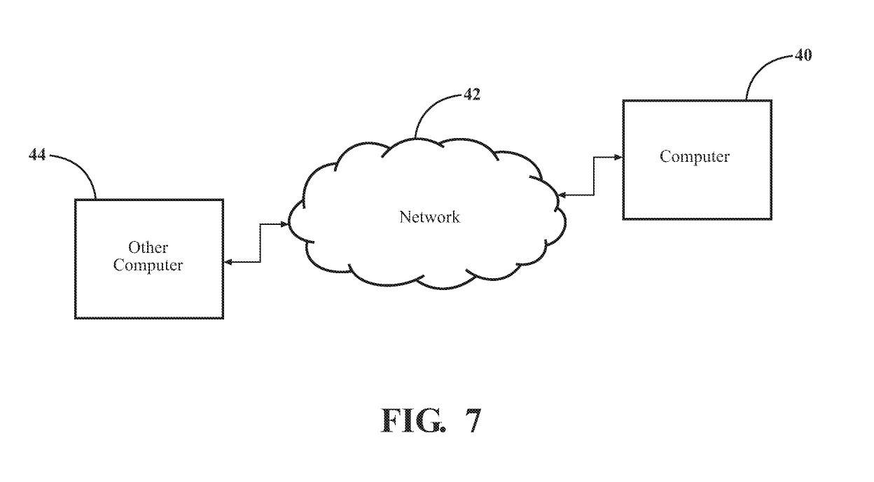

As shown in FIG. 7, the program 36 may be configured for operating via the network 42. Examples of networks may include local-area networks (LANs), wide-area networks (WANs), campus-area networks (CANs), and metropolitan-area networks (MANs). One example of the network 42 is a cloud computing model. Examples of cloud computing delivery include, but are not limited to, software as a service (SaaS), infrastructure as a service (IaaS), platform as a service (PaaS), desktop as a service (DaaS), backend as a service (BaaS), and information technology management as a service (ITMaaS).

Also as shown in FIG. 7, the network 42 may be used for facilitating electronic communication between electronic computing devices or computers. Examples of a computer 40 may include mainframe, workstation, desktop, laptop, tablet, hand-held, eyewear, and smart phone computers. Examples of eyewear computers may include Glass™ manufactured by Google Inc. Additional examples of computers may include hand-held devices used for detecting the presence of any pathogen within or on any of the samples. Hand-held devices may be operated by third-party entities. Workstations may be installed at the site 30.

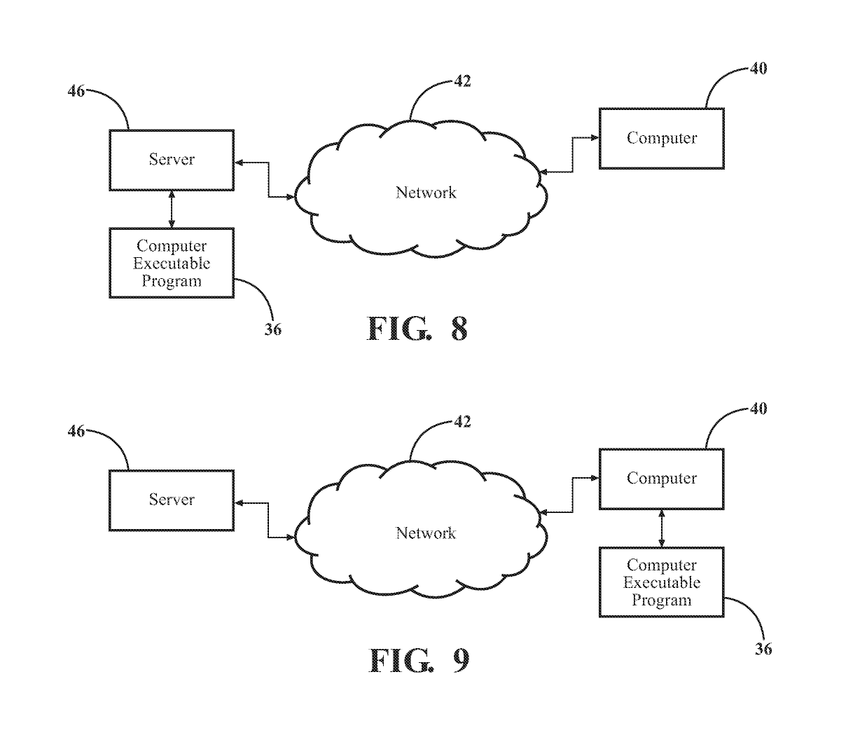

As shown in FIG. 8, a server 46 may be in electronic communication with the network 42. More specifically, a computer 40 may be in communication with the server 46 through the network 42. The server 46 may host the program 36 such that the computer 40 can electronically access the program 36 from the server 46 across the network 42.

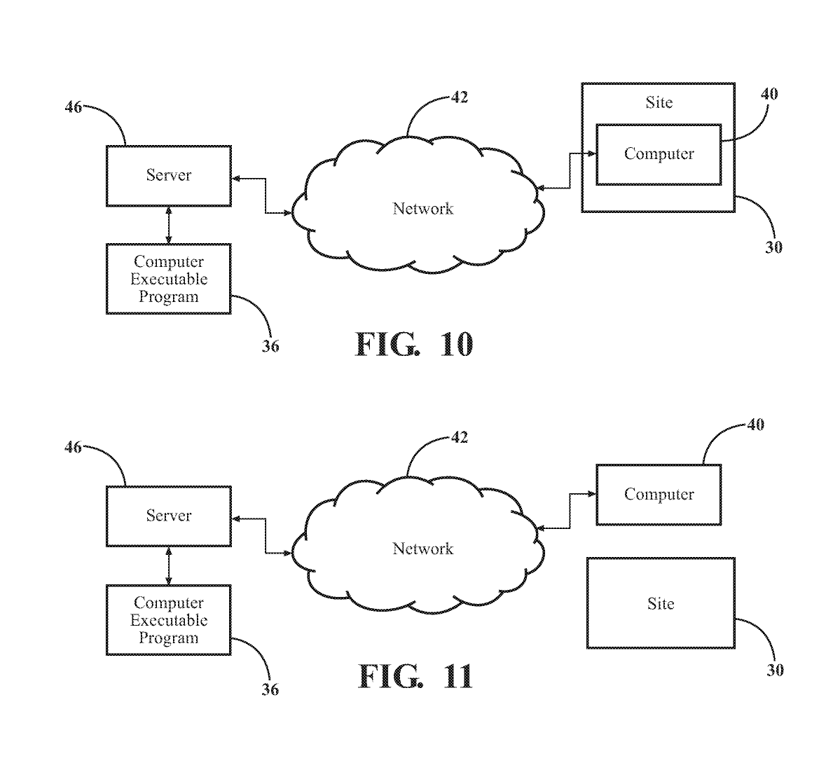

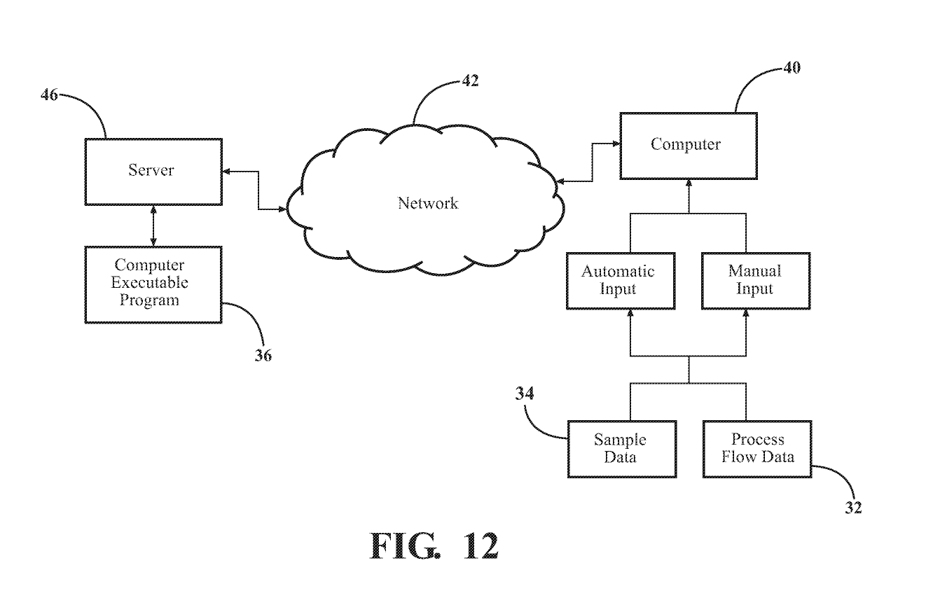

As shown in FIG. 9, the program 36 may be implemented on the first computer 40. The first computer 40 may be located inside or outside the site 30. As shown in FIG. 10, the first computer 40 is located inside of the site 30. Alternatively, as shown in FIG. 11, the first computer 40 is located outside of the site 30. The program 36 may be accessed via the first computer 40. The program 36 may be implemented as a mobile app or desktop app. The program 36 may be downloadable locally to the computer 40, streamed via the remote server 46, and the like.

a. Inputting Data into the Program

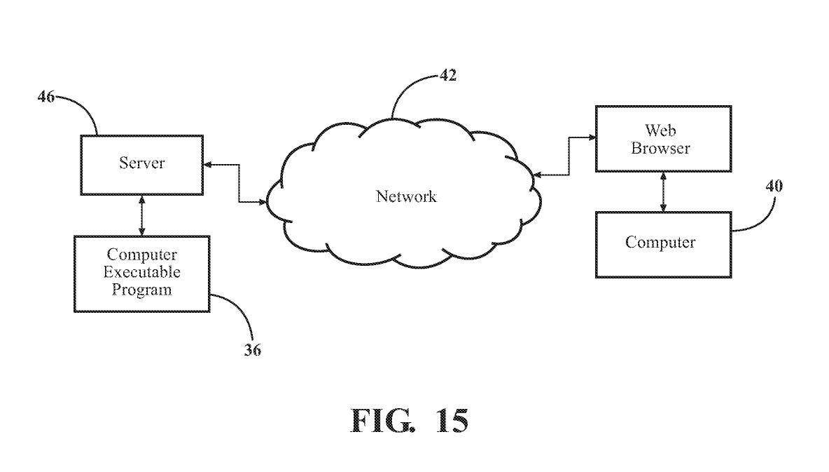

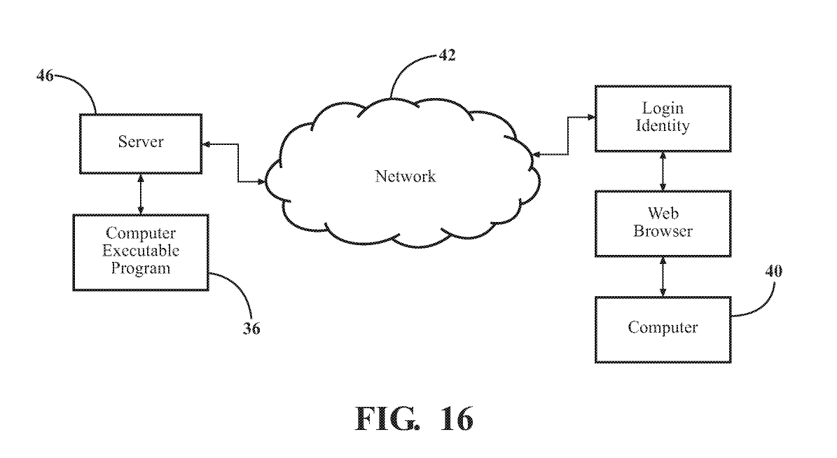

As shown in FIG. 15, the program 36 may be electronically accessed through a web-browser on the first computer 40. As shown in FIG. 16, accessing the program 36 may also include entering a login identity.

The sampling data 34 captured may be exported to a computer-based document or file, which can be sent, or uploaded periodically (e.g., nightly) to the service provider. The program 36 may be configured to autonomously collect and index the received sampling data 34 for evaluation. Alternatively, the program 36 may receive the sampling data 34 via manual input into the computing device. Either of these techniques may be similarly implemented for the process 32.

Data is electronically inputted into the program 36 in an electronic format. As such, flow data 32 generated during the performance of the flow analysis is transformed into an electronic format before being electronically inputted into the program 36. Likewise, sampling data 34 generated during sampling is transformed into an electronic format before being electronically inputted into the program 36. Examples of transforming data into an electronic format may include converting non-digital recordings into digital recordings. Non-digital recordings may include reports, instructions, audits, inventories, logs, schedules, and pictures. Converting non-digital recordings to digital recordings may be performed with equipment, such as, but not limited to, optical scanners. Those skilled in the art appreciate that the flow data 32 and sampling data 34 may be electronically transformed and inputted by various other methods not described herein.

As shown in FIG. 12, electronically inputting flow data 32 and sampling data 34 into the program 36 may be performed manually, automatically, or any combination thereof. Inputting flow data 32 and sampling data 34 into the program 36 may also be performed at the same or different times. Additionally, inputting flow data 32 and sampling data 34 into the program 36 may be performed any number of times. Inputting flow data 32 and sampling data 34 into the program 36 may also be performed for any sampling data 34 set, flow data 32 set, and combinations thereof.

Flow data 32 and sampling data. 34 are inputted into the program 36 with the first computer 40. Additionally or alternatively, flow data 32 and sampling data 34 are inputted into the program 36 with a second computer 44. The second computer 44 may be located inside or outside the site 30. Data electronically inputted into the program 36 is electronically transmitted between computers and servers in communication with each other through the network 42, Additionally, data inputted into the program 36 may be stored in memory on the first computer 40, the second computer 44, or both.

In one example, the flow data 32 is inputted using specialized detection components that are connected to or in communication with the computer 40. For example, the computer 40 may include camera and motion tracking recognition technologies for automated identification of objects based on pattern or shape recognition and for tagging the identified objects. Additionally, the computer 40 may track identity, location, and time data relating to the computer 40 itself or to the objects at the site. Such technology may perform such processes whether the computer 40 is stationary or mobile, i.e., moving throughout the site 30. In other embodiments, wireless technologies, such as RFID or NFC technology may be utilized for tracking movement of staff, patient and equipment, and the like.

b. Generating Evaluated Data

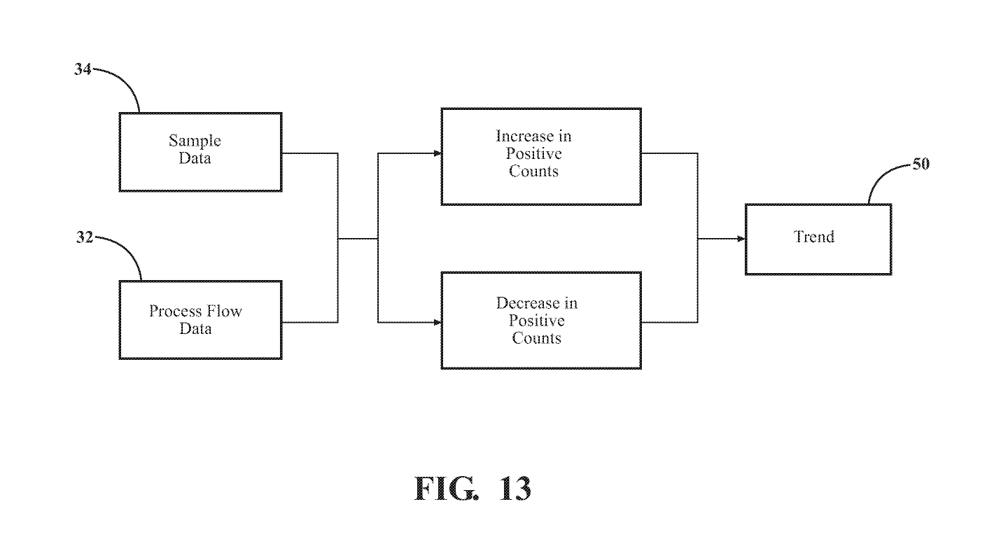

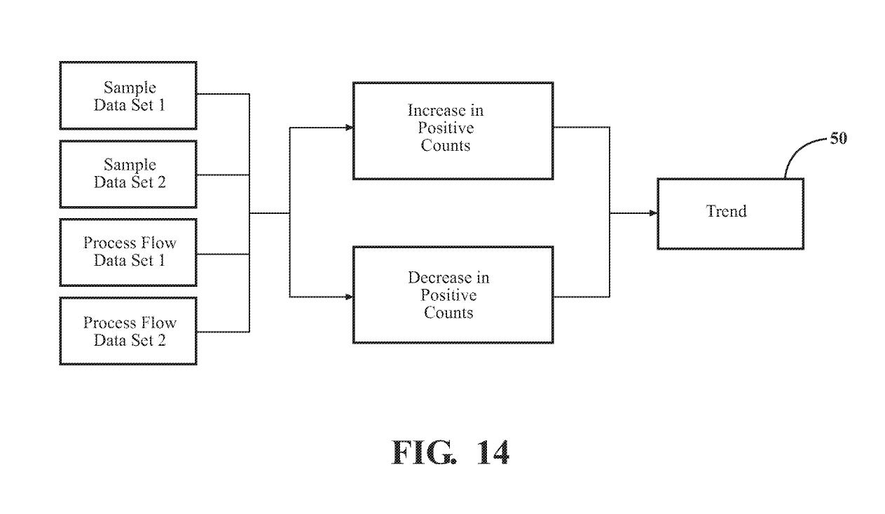

The program 36 electronically evaluates inputted flow data 32 and sampling data 34. As shown in FIG. 13, the program 36 may electronically evaluate inputted flow data 32 and sampling data 34 by electronically identifying trends 50 in the data. Trends 50 in the inputted data may include an increasing or decreasing positive count associated with a location or object at the site 30 over time. As shown in FIG. 14, the program 36 may electronically identify trends 50 in multiple flow and sample data sets. The program 36 may identify trends 50 by comparing any combination of inputted flow and sample data sets. The program 36 may generate an alert 52, such as a visual alert, and/or a graphical indicator based on the trends 50 identified during evaluating the flow and sampling data 34, as described in further detail below. The program 36 may employ any suitable algorithm for electronically determining trends or patterns in the flow data 32 and sampling data 34.

The program 36 may also identify the spread of pathogens at the site 30 by evaluating the inputted data. The spread of pathogens at the site 30 includes the change in the location of pathogens in relation to the layout of the site 30, over time. The spread of pathogens at the site 30 may include initial locations, current locations, final locations, or combinations thereof. The initial locations of pathogens may include the locations at the site 30 where pathogens were present before beginning to flow through the site 30. The initial locations of pathogens at the site 30 may also include the locations where pathogens were first detected at the site 30. The current locations of pathogens may include the locations where pathogens were last detected at the site 30. The final locations of pathogens may include the locations where pathogens were last detected at the site 30 before being eliminated from the facility. Notably, because the program 36 takes into account movement of the objects at the site 30 over time, and detailed sampling data 34 over time, the program 36 can analyze how specific pathogens are moving throughout the site 30 in relation to the objects at the site. This allows the program 36 to determine the a source, cause or condition, at the site 30 that is causing the pathogens to spread as well as the flow of movement of how pathogens spread at the site 30. The source, cause or condition may be a root source, cause or condition, initiated within the site 30.

The program 36 electronically evaluates the inputted data by identifying patterns in the data. Patterns in the data include, but are not limited to, recurring trends. A recurring trend is an increase or decrease in the number of positive counts associated with an object or location at the site 30, which happens at more than one time. Examples of recurring trends may include an increase or decrease in the number of positive counts associated with the site 30 at a certain time of year, such as, but not limited to, an increase or decrease in positive counts throughout the site 30 during the month of June in two sequential years. Example of recurring trends may also include an increase or decrease in the number of positive counts associated with an object or location at the site 30 each time the object or location is cleaned by the same person. Examples of recurring trends may further include an increase or decrease in the number of positive counts associated with an object or location at the site 30 each time the object or location is cleaned using the same cleaning procedure. Examples of recurring trends may additionally include an increase or decrease in the number of positive counts associated with an object or location at the site 30 each time the object or location is cleaned using the same cleanser. Examples of recurring trends may also include an increase or decrease in the number of positive counts associated with an object or location at the site 30 each time the object or location is cleaned using the same cleanser. Other types of patterns or trends may be determined.

c. Displaying the Data

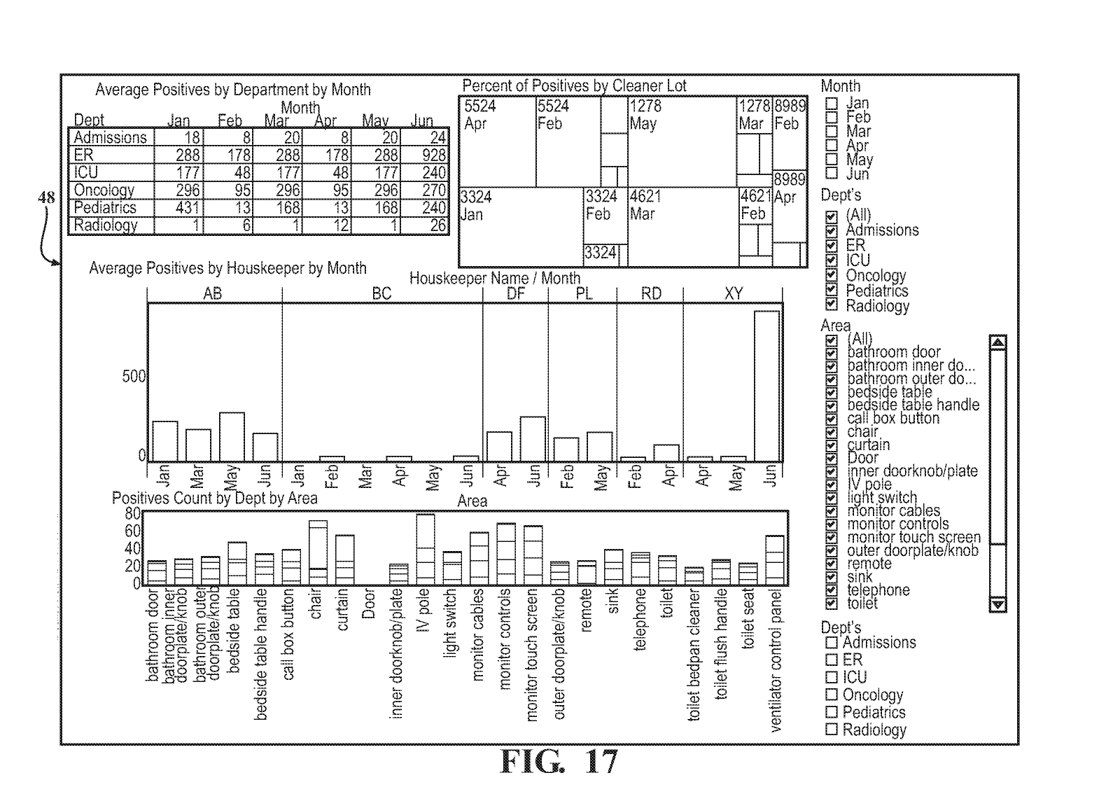

As shown in FIGS. 17-21, the program 36 electronically displays evaluated data 38 in a graphical user interface 48 (GUI) or by using graphical indicators. The graphical indicator is informative of pathogen dynamics within the site. For example, the graphical indicator may indicate how identified pathogens move within the site over time. The graphical indicator, collectively accounts for the time, place, and location of identified pathogens.

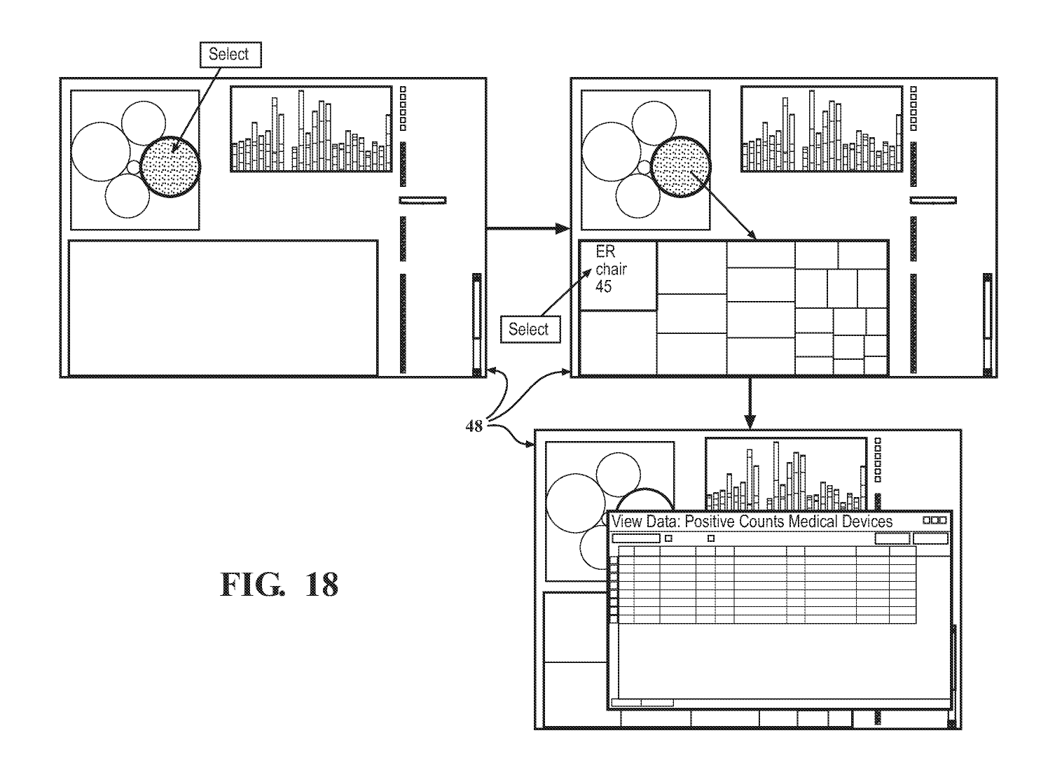

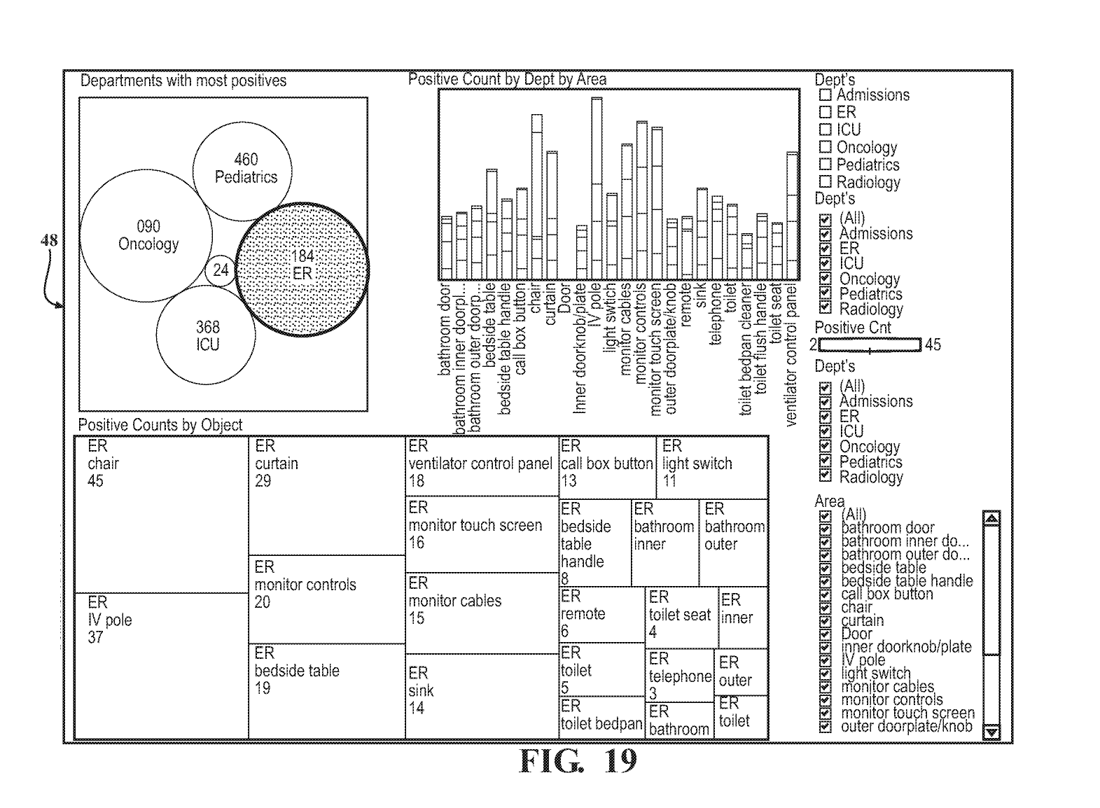

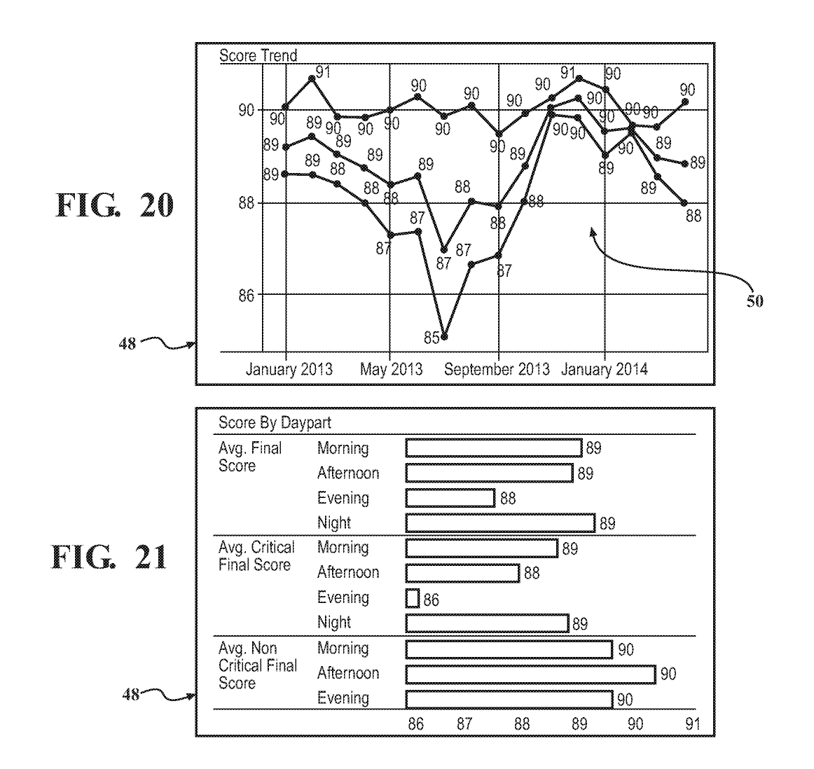

The computing device is configured to generate such graphical indicators based on evaluating the flow data and the sampling data. Such graphical indicators are displayable on any suitable device. The graphical indicator may be two-dimensional, three-dimensional, augmented reality, virtual, holographic, or the like. The evaluated data 38 may be displayed on a display that is in communication with, or integrated with the computing device. The program 36 may additionally display portion of inputted flow data 32 and sampling data 34. The graphics may be interactive and/or dynamic such that evaluated data 38 may be selected by electronically selecting an icon or the like relating to the graphics to analyze the underlying evaluated data 38 from which the graphic is based. As shown in FIG. 17, icons in the GUI 48 may appear as words, symbols, pictures, or combinations thereof. As shown in FIG. 18, responsive to selecting icons in the GUI 48, the program 36 may electronically display graphics corresponding to the selected icon in a way that facilitates visualizing the evaluated data 38. Again, the GUI 48 may electronically display flow data 32, sampling data 34, evaluated data 38, or combinations thereof. Examples of the way the program 36 may display data to facilitate visualizing related data may include diagrammatical illustrations. Examples of diagrammatical illustrations may include, but are not limited to, timelines, tables, lists, heat maps, graphs, plots, and charts. Examples of graphs may include, but are not limited to, circle graphs, line graphs, bar graphs, stacked graphs, pictographs, histograms, and time series graphs. Examples of plots may include, but are not limited to, dot plots, scatter plots, cumulative plots, and stem-and-leaf plots. Examples of charts may include, but are not limited to, pie charts, ring charts, flow charts, bubble charts, spie charts, brick charts, and line charts. As shown in FIG. 19, the program 36 may display information within the GUI 48 including a department, areas within the department, objects within the department, and positive counts generated from sampling the objects and areas within the department all on one screen. For example, FIG. 19 provides a screen shot of the program 36 displaying that 45 positive counts were generated from detecting the presence of pathogens on chairs in the emergency room department. Additionally, the program 36 may display graphical indicators in the form of trends 50 in the GUI 48. As shown in FIG. 20, the program 36 may display trends 50 graphically as a scatter plot, allowing for visualization of the upward and downward trends in the data over time. The program 36 may also display direct comparisons of data sets using the GUI 48. As shown in FIG. 21, the program 36 may display data sets graphically as a bar chart, allowing for visual comparison of two or more data from multiple data sets. The program 36 may display trends 50 and comparisons of evaluated data 38, flow data 32, sampling data 34, and combinations thereof.

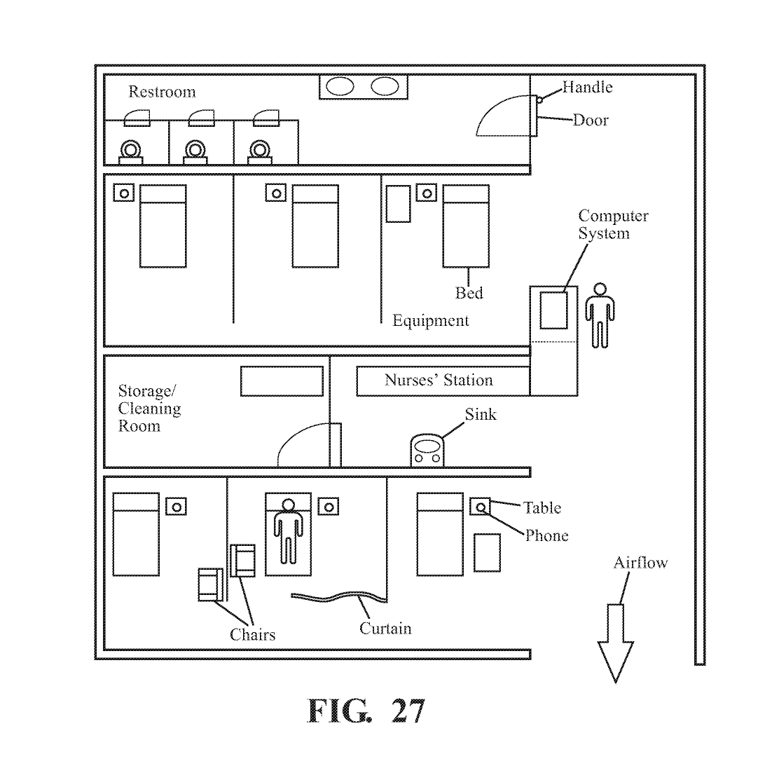

FIG. 27 is an example of the virtual representation of the site 30, which in this example is hospital unit, that is provided by the computing device. The virtual representation is generated by the program 36 based on at least the flow data 32. The virtual representation represents the different areas or rooms at the site 30, including, but not limited to the restroom, nurses' station, storage/cleaning room, corridor/hallway, patient units and the like. The virtual representation also represents the objects at the site 30, such as those described herein or any equivalents not described herein. The location and movement of the objects may be represented or animated with respect to the virtual layout of the site 30.

The program 36 generates graphical indicators based on evaluating the flow data 32 and the sampling data 34, i.e., based on the evaluated data. The graphical indicator is informative of movement of the identified pathogens within the site over time and is visually displayable. The graphical indicator may include any suitable graphics described herein or equivalents of the not specifically described herein.

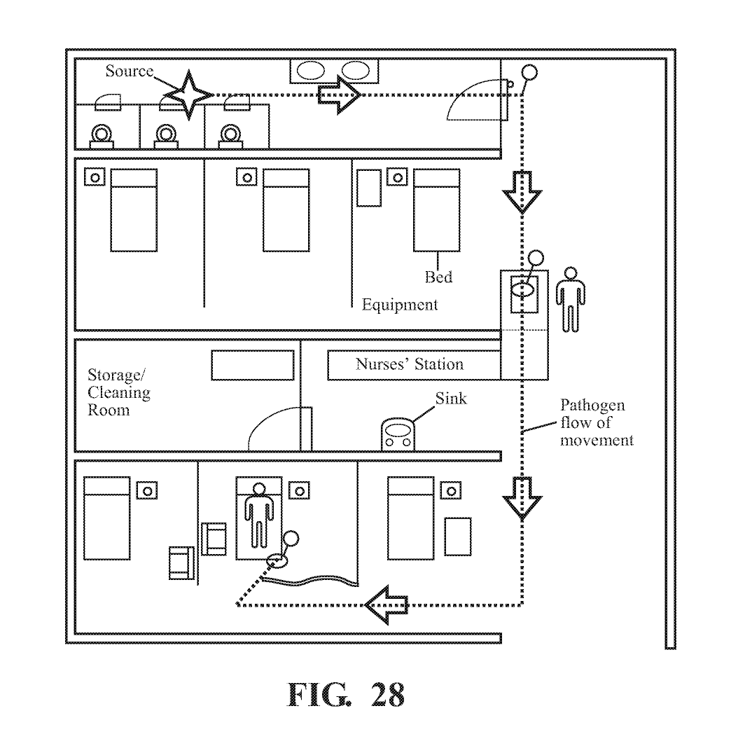

FIG. 28 is provides example(s) of graphical indicators being overlaid on the virtual representation of the site of FIG. 27. The program 36 is configured to determine a source, cause or condition initiating to spread identified pathogens at the site 30 based on the evaluation of the flow data 32 and the sampling data 34, i.e., the evaluated data. As shown in FIG. 28 the determined source, cause or condition initiating to spread identified pathogens at the site is graphically presented. One example of this graphical indicator is a marker, e.g., a star, which is overlaid at the location of the identified source of initiating spread of the pathogens based on the evaluated dynamics. The determined source is indicated with a symbol at the specific location of the site 30 where the identified pathogen is predicted to originate based on movement of the identified pathogens. An animation or representation of the cause or condition initiating spread of the identified pathogens may also be provided on the virtual representation. The program 36 may extrapolate or interpolate the source based on the evaluated data. The source of the pathogens may be predicted or may be definite.

The program 36 may also determine a path of movement of the identified pathogens at the site 30 based on the evaluation of the flow data 32 and the sampling data 34, i.e., the evaluated data. The determined path of movement of the identified pathogens at the site 30 may also be graphically presented. In one embodiment, these determinations are graphically presented on the virtual representation. The program 36 displays a predicted path of movement of the pathogens on the virtual layout. By doing so, the program 36 provides clear visual aides to assist in the investigation of pathogens spreading at the site 30. The graphical indicator may also include pin-points of hot spots for pathogens. The pin-points may be tagged to certain objects at the site 30. The program 36 may allow selections into the object representations or pin-points provided in virtual layout to see sampling data 34 and flow data 32 associated with the object. The program 36 may utilize the hot spots to extrapolate, interpolate, or aggregate the path of movement. The path of movement may be predicted or may be definite.

In other embodiments, augmented reality may be utilized to overlay the graphical indicators over a real image of the site 30. For example, if the source of the pathogens is determined to be located at the handle of a restroom door, the graphical indicator may be dynamically superimposed over a real camera image of the restroom to virtually indicate the precise location of the source. Similar augmented reality techniques may be utilized to display a virtual representation of the determined path of movement of the pathogens over real camera images or video of walkways or corridors, hallways of the site 30, and the like.

d. Alerts

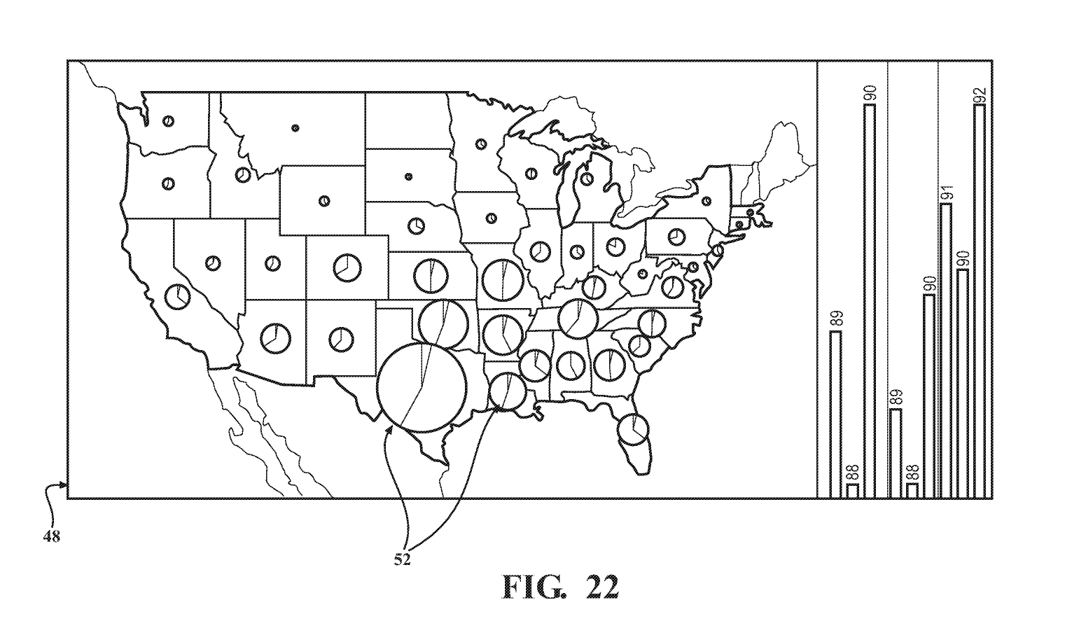

The program 36 may issue alerts 52 after identifying trends 50 in the inputted data. As shown in FIG. 22, the program 36 may display alerts 52 as icons in the GUI 48. Additionally, the program 36 may display any number of different alerts 52 in the GUI 48. The program 36 may issue alerts 52 when trends 50 increase or decrease more than a threshold amount. The program 36 evaluates the trends 50 in the inputted data and determines whether the threshold amount was reached. The threshold amount to cause an alert 52 may be set to any value. Additionally, a different threshold amount to cause an alert 52 may be set for the trend associated with each individual location or object displayed in the GUI 48. Each of the different threshold amounts may be set to any value. Examples of the threshold amount may include an increase, or decrease, of 1, 3, 5, or 10 positive counts. Alternatively, the program 36 may issue an alert 52 to suggest corrective actions, as described in further detail below.

e. Portals

The program 36 may include one or more portals. The level of access to data that is displayed by the program 36 in the GUI 48 may be controlled via the portals. The program 36 may choose which portal will be displayed in the GUI 48 based on the login identity used to access the program 36. Each portal may be accessed by any number of different login identities. Additionally, some portals may include more data than other portals, such that a hierarchy of portals may exist based on the amount of data included in each portal. For example, the program 36 may display alerts 52 in the GUI 48 of a single portal, or the GUIs 48 of multiple portals. The program 36 may choose which portals to display the alert 52 in based on the access of the portals to the data corresponding to the trend that caused the alert 52. In other words, the program 36 may only display the alert 52 in portals with access to the data associated with the alert 52.

f. Dashboards

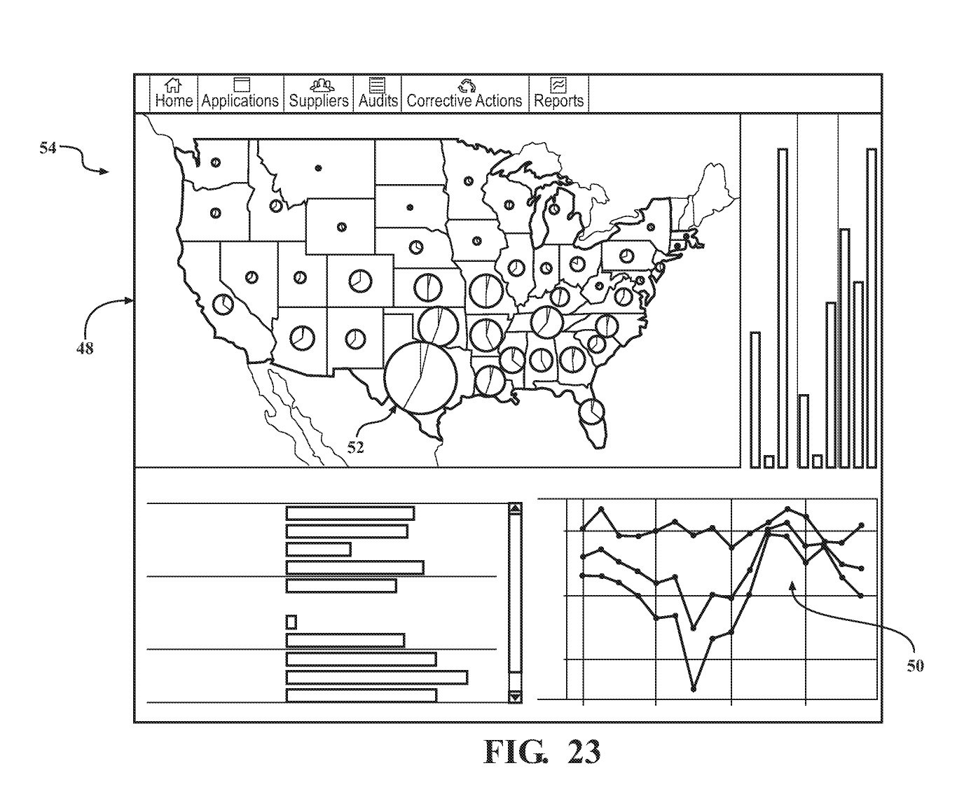

The portals of the program 36 may also include electronic dashboards 54. As shown in FIG. 23, the program 36 may display the dashboards 54 in the GUIs 48 of the portals. The program 36 may display information on the dashboards 54, including evaluated data 38, alerts 52, and combinations thereof. The program 36 may also display real-time information on the dashboards 54, such as, but not limited to, the most recent evaluated data 38, and current alerts 52. The program 36 may also display on the dashboards 54 alerts 52 and evaluated data 38 from one or more remote or local facilities 30.

VI. Uses

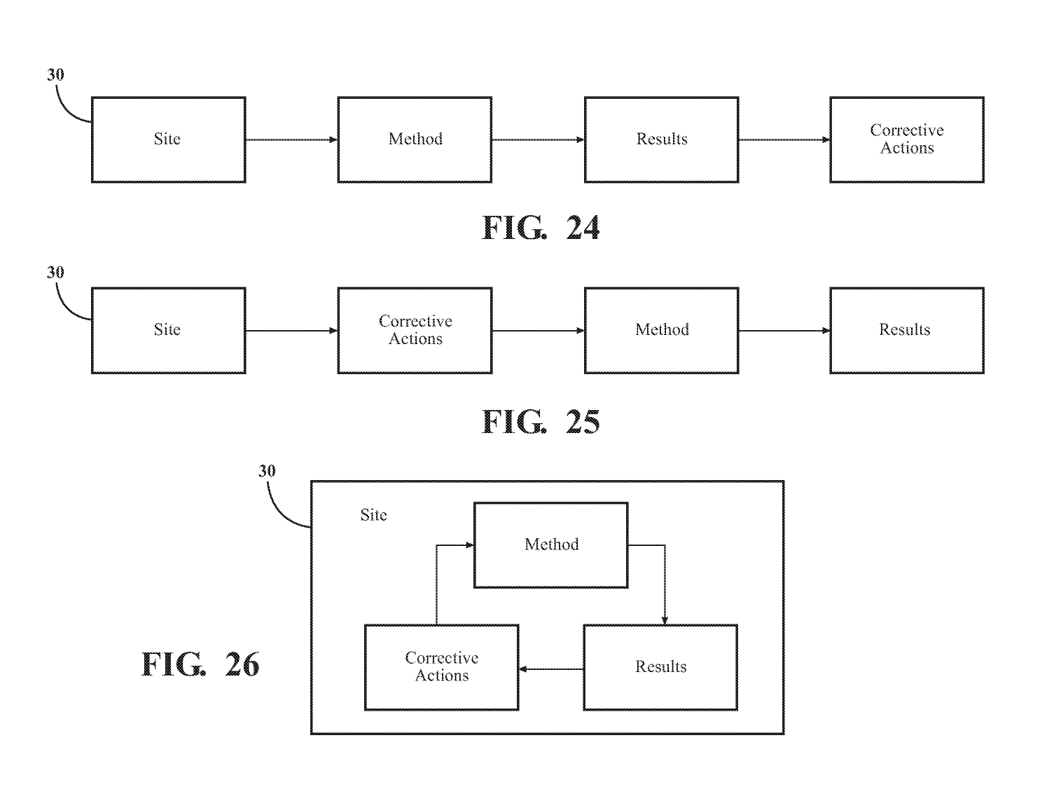

As shown in FIG. 24, the system and method may be used to evaluate the presence of pathogens at the site 30 before, during, or after performing corrective actions. Corrective actions are actions taken to treat pathogens at the site 30. Such corrective actions include, but are not limited to, changing the procedures, policies, cleansers, or objects used at the site 30, or any combinations thereof. Such corrective actions are aimed at reducing or eliminating the existence of pathogens at the site 30, or at certain locations at the site 30. One example of corrective action is to recommend hygiene improvement based on trending and predictive assessment.

Evaluating the presence of pathogens at the site 30 before performing corrective actions may be used to influence the type, method, location, procedure, or any combination thereof, of corrective actions to be performed to treat the pathogens. For instance, the program 36 may use the flow data 32 and sampling data 34 to identify trends 50 of increasing positive counts associated with one object in a room of the site 30. The program 36 may also use flow data 32 and sampling data 34 to identify trends 50 of decreasing positive counts associated with another object in the same room of the site 30. The program 36 may then compare the flow data 32 and sampling data. 34 associated with each object in the room and identify differences and similarities in the flow data 32 and sampling data 34. The program 36 may identify differences and similarities in the flow data 32 and sampling data 34 associated with the objects such as, but not limited to, the procedures used to clean the objects, the person used to clean the objects, the cleansers used to clean the objects, and the frequency at which the objects were cleaned.

The program 36 may then display the identified differences and similarities in the flow data 32 and sampling data 34 in the GUI 48. The differences or similarities displayed by the program 36 in the GUI 48 may then be used to influence corrective actions taken to reduce the positive counts associated with the object having the increasing trend. Examples of corrective that may be taken to reduce the positive counts may include altering the procedures used to clean the one object to homogenize the procedures used to clean both objects, such that the effectiveness of the procedures is increased. Examples of corrective actions that may be taken to reduce the positive counts may also include training the person used to clean the one object to homogenize the cleaning performed by the people on both objects, such that the effectiveness of the people cleaning the objects is increased. Examples of corrective that may be taken to reduce the positive counts may further include altering the cleansers used to clean the one object to homogenize the cleansers used to clean both objects, such that the effectiveness of the cleansers used the clean the objects is increased. Those skilled in the art realize that other corrective actions may be taken based on the identified patterns and trends displayed by the program 36.

In one example, the program 36 may identify from flow data. 32 and sampling data 34 that a curtain in a room of a site 30 is associated with a higher number of positive counts than a floor in the same room. The program 36 may also identify from flow data 32 and sampling data 34 that objects transmit pathogens to the curtain more frequently than objects transmit pathogens to the floor. The program 36 may also identify from flow data. 32 that the curtain and the floor are cleaned with the same frequency. The program 36 may then display in the GUI 48 the identified difference in the usage frequencies, and similarity in the cleaning frequencies, of the curtain and the floor. The displayed difference in the usage frequencies and similarity in the cleaning frequencies may be used to influence corrective actions taken to reduce the number of positive counts in the room of the site 30. In this example, a corrective action that may reduce the number of positive counts associated with the room of the site 30 may include increasing the cleaning frequency of the curtain.

As shown in FIG. 25, the system and method may also be used to evaluate the presence of pathogens at the site 30 after performing corrective actions to treat the pathogens. The results of evaluating the presence of pathogens at the site 30 after performing corrective actions may be used to generate an alert 52. The alert 52 may signal the presence of the pathogens after the corrective actions were performed. For instance, the program 36 may evaluate flow data 32 and sampling data 34 associated with a location or object at the site 30 inputted after a corrective action was taken to reduce the number of positive counts associated with the location or object. In one example, the corrective action to reduce the number of positive counts associated with the room at the site 30 may include increasing the cleaning frequency of the curtain in the room. Sampling data 34 and flow data 32 may be generated from the room after the corrective action, and inputted into the program 36. The program 36 may then evaluate the inputted flow data. 32 and sampling data 34 by analyzing the number of positive counts associated with the curtain after the corrective action. The program 36 may then compare the number of positive counts associated with the curtain to the threshold amount set for the curtain. If the number of positive counts associated with the curtain is greater than the threshold amount set for the curtain, the program 36 will issue the alert 52 and further corrective actions may be taken to reduce the number of positive counts associated with the curtain. Alternatively, if the number of positive counts associated with the curtain is less than the threshold amount set for the curtain, the program 36 will not issue an alert 52.

The program 36 may be configured to electronically suggest or predict a corrective action to treat pathogens at the site 30 based on evaluating the inputted flow data 32 and sampling data 34. The program 36 may also analyze determined trends 50 or patterns and suggest the corrective action based on the analysis of the trends 50 or patterns. The program 36 may suggest the corrective action by issuing an alert 52 in the GUI The program 36 may employ any suitable algorithm for determining which corrective action to suggest based on the evaluated data 38. In one embodiment, the corrective action is not predetermined, but rather formed directly by the program 36 inferring the corrective action directly from the evaluated data 38. Alternatively, the program 36 may have access to an electronic library of predetermined corrective actions and electronically select a predetermined corrective action from the library based on the evaluated data 38.

Determinations of corrective actions to treat pathogens at the site 30 may be manually conducted. For example, after the program 36 displays trends or patterns, a user of the program 36 may assess the trends or patterns and formulate an appropriate corrective action.

As shown in FIG. 26, the program 36 may also be configured to electronically validate and invalidate corrective actions by evaluating the presence of pathogens at the site 30 before and after performing corrective actions. In validating the corrective action, the program 36 determines the effectiveness of the corrective action by electronically comparing the flow data 32 and sampling data 34 inputted after the corrective action is implemented to the flow data 32 and sampling data 34 inputted before the corrective action is implemented. For instance, the program 36 may electronically evaluate flow data 32 and sampling data 34 associated with a location or object at the site 30 inputted both before and after a corrective action was taken to reduce the number of positive counts associated with the location or object. In one example, the corrective action to reduce the number of positive counts associated with a room at the site 30 may include increasing the cleaning frequency of a door handle in the room. Sampling data 34 and flow data 32 may be generated from the room both before and after the corrective action, and inputted into the program 36. The program 36 may then evaluate the inputted flow data 32 and sampling data 34 by comparing the number of positive counts associated with the door handle from before and after the corrective action. The program 36 may then identify trends 50 in the flow data 32 and sampling data 34 by identifying whether the number of positive counts associated with the door handle increased or decreased after the corrective action was performed. The program 36 may then be used to validate the corrective action if the number of positive counts associated with the door handle decreased after the corrective action.

The program 36 may be used to invalidate corrective actions by electronically evaluating the presence of pathogens at the site 30 before and after performing corrective actions. In invalidating the corrective action, the program 36 determines the ineffectiveness of the corrective action based on comparing the flow data 32 and sampling data 34 inputted after the corrective action is implemented to the flow data 32 and sampling data 34 inputted before the corrective action is implemented. For instance, a corrective action to reduce the number of positive counts associated with a room at the site 30 may include increasing the cleaning frequency of a toilet in the room. Sampling data 34 and flow data 32 may be generated from the room both before and after the corrective action, and inputted into the program 36. The program 36 may then evaluate the inputted flow data 32 and sampling data 34 by comparing the number of positive counts associated with the toilet from before and after the corrective action. The program 36 may then identify trends 50 in the flow data 32 and sampling data 34 by identifying whether the number of positive counts associated with the toilet increased or decreased after the corrective action. The program 36 may then be used to invalidate the corrective action if the number of positive counts associated with the toilet increased after the corrective action.

It is an object of the appended claims to cover all such modifications and variations that come within the true spirit and scope of this invention.

What is claimed is:

1. A system for investigating the spread of pathogens at a site, said system comprising:
a computing device;
a display in communication with said computing device;
said computing device being configured to receive flow data indicating an identity and location of objects at the site and movement of the objects within the site over time;
said computing device being configured to receive sampling data indicating a presence of pathogens on the objects over time and an identity of pathogens that are present;
said computing device being configured to evaluate said flow data and said sampling data;
wherein said computing device is configured to generate a graphical indicator based on evaluating said flow data and said sampling data, wherein said graphical indicator is informative of movement of the identified pathogens within the site over time; and
wherein said display is configured to visually present said graphical indicator.

2. The system of claim 1 wherein said computing device is configured to provide a virtual representation of the site, said virtual representation being presentable on said display.

3. The system of claim 2 wherein said graphical indicator indicates a source, cause or condition initiating spread of the identified pathogens at the site, wherein said graphical indicator indicating the source, cause or condition is graphically presentable on said virtual representation of the site.

4. The system of claim 2 wherein said graphical indicator is a path of movement of the identified pathogens within the site, wherein said graphical indicator of said path of movement of the identified pathogens is graphically presentable on said virtual representation of the site.

5. The system of claim 1 wherein said graphical indicator is a dynamic user interface presenting patterns or trends correlating said flow data and said sampling data over time.

6. The system of claim 1 wherein said flow data further includes cleaning data about the objects at the site.

7. The system of claim 6 wherein said computing device is configured to suggest a corrective action to prevent, reduce or eliminate spread of the identified pathogens at the site based on evaluating said sampling data and said flow data including said cleaning data.

8. The system of claim 1 wherein said computing device is configured to suggest a monitoring and sampling plan for the site based on evaluating said flow data.

9. The system of claim 1 wherein said flow data is generated at least in part by sensors or tags associated with the objects wherein location and movement of said sensors or tags are electronically detectable within the site over time.

10. A computer-implemented method for investigating the spread of pathogens at a site using a computing device and a display in communication with the computing device, said method comprising the steps of:
receiving flow data with the computing device, the flow data indicating an identity and location of objects at the site and movement of the objects within the site over time;
receiving sampling data with the computing device, the sampling data indicating a presence of pathogens on the objects over time and an identity of pathogens that are present;
evaluating the flow data and the sampling data with the computing device;
generating with the computing device a graphical indicator based on evaluating the flow data and the sampling data, wherein the graphical indicator is informative of movement of the identified pathogens within the site over time; and
visually presenting the graphical indicator on the display.

11. The computer-implemented method of claim 10 further comprising the step of providing a virtual representation of the site with the computing device, the virtual representation being presentable on the display.

12. The computer-implemented method of claim 11 further comprising the step of indicating, with the graphical indicator, a source, cause or condition initiating spread of the identified pathogens within the site and presenting the graphical indicator indicating the source, cause or condition on the virtual representation of the site.

13. The computer-implemented method of claim 11 further comprising the step of indicating, with the graphical indicator, a path of movement of the identified pathogens within the site and presenting the graphical indicaor indicating the path of movement of the identified pathogens within the site on the virtual representation of the site.

14. The computer-implemented method of claim 10 further comprising the step of presenting, with the graphical indicator, patterns or trends correlating the flow data and the sampling data over time.

15. The computer-implemented method of claim 10 further comprising the step of generating, with the computing device, an alert, or a suggestion to prevent, reduce or eliminate spread of the identified pathogens within the site, based on evaluating the flow data and the sampling data.

16. The computer-implemented method of claim 10 wherein the step of receiving flow data further comprises receiving cleaning data about the objects at the site.

17. The computer-implemented method of claim 16 further comprising the step of suggesting, with the computing device, a corrective action to prevent, reduce or eliminate spread of the identified pathogens within the site based on evaluating the sampling data and the flow data including the cleaning data.

18. The computer-implemented method of claim 10 further comprising the step of suggesting, with the computing device, a monitoring and sampling plan for the site based on evaluating the flow data.

19. The computer-implemented method of claim 10 further comprising the step of generating the flow data at least in part by sensors or tags associated with the objects and electronically detecting location and movement of the sensors or tags within the site over time.

20. A non-transitory computer-readable medium having stored therein computer-readable instructions for a processor, wherein said instructions when executed by the processor cause the processor to:
receive flow data indicating an identity and location of objects at the site and movement of the objects within the site over time;
receive sampling data indicating a presence of pathogens on the objects over time and an identity of pathogens that are present;
evaluate the flow data and the sampling data; and
generate a graphical indicator based on evaluating the flow data and the sampling data, wherein the graphical indicator is informative of movement of the identified pathogens within the site over time and is visually displayable.
